(19) United States
(12) Patent Application Publication
(10) Pub. No.: US 2026/0059548 A1
(43) Pub. Date: Feb. 26, 2026

(54) TECHNIQUES FOR CHANNEL ACCESS-AWARE CONFLICT DETERMINATION FOR UNLICENSED SIDELINK BANDS

(71) Applicant: QUALCOMM INCORPORATED, San Diego, CA (US)

(72) Inventors: Shaozhen Guo, Beijing (CN); Changlong Xu, Beijing (CN); Jing Sun, San Diego, CA (US); Xiaoxia Zhang, San Diego, CA (US); Chih-Hao Liu, San Diego, CA (US); Siyi Chen, Beijing (CN); Luanxia Yang, Beijing (CN); Hao Xu, Beijing (CN)

(21) Appl. No.: 18/998,959

(22) PCT Filed: Sep. 30, 2022
(86) PCT No.: PCT/CN2022/123168

§ 371 Date: Jan. 27, 2025

(51) Int. Cl. H04W 72/25; H04W 16/14; H04W 72/542

(52) U.S. Cl. CPC H04W 72/25; H04W 16/14; H04W 72/542

(57) ABSTRACT

Methods, systems, and devices for wireless communications are described. A first user equipment (UE) may be configured to receive, from a second UE, a first sidelink control message indicating a first reserved resource to be used by the second UE for sidelink communications in a shared radio frequency spectrum band. The first UE may additionally receive, from a third UE, a second sidelink control message indicating a second reserved resource to be used by the third UE for sidelink communications in the shared radio frequency spectrum band. The first UE may transmit an indication of a conflict between the first and second reserved resources based on the first and second reserved resources overlapping in time and frequency, a signal strength for a signal received from the second UE, the third UE, or both, and a channel access parameter for communications with the second UE, the third UE, or both.

### CROSS REFERENCE

The present Application is a 371 national stage filing of International PCT Application No. PCT/CN2022/123168 by Guo et al. entitled “TECHNIQUES FOR CHANNEL ACCESS-AWARE CONFLICT DETERMINATION FOR UNLICENSED SIDELINK BANDS,” filed Sep. 30, 2022, which is assigned to the assignee hereof, and which is expressly incorporated by reference in its entirety herein.

### FIELD OF TECHNOLOGY

The following relates to wireless communications, including techniques for channel access-aware conflict determination for unlicensed sidelink bands.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications, wireless devices (e.g., UEs) may be able to communicate with one another directly using sidelink communications. Different mechanisms may be employed to reduce interference in sidelink bands. In some cases, UEs may exchange inter-UE coordination messages to reserve resources for sidelink communications. In other cases, UEs may perform listen-before-talk (LBT) procedures to reduce interference. However, current techniques for reducing interference in sidelink bands may still result in interference.

### SUMMARY

The described techniques relate to improved methods, systems, devices, and apparatuses that support techniques for channel access-aware conflict determination for unlicensed sidelink bands. Generally, the described techniques provide for configurations and conditions which enable user equipments (UEs) to determine whether conflicts exist between reserved resources in unlicensed sidelink bands based on one or more channel access parameters. In some cases, the channel access parameters may be used to determine a relative probability that listen-before-talk (LBT) procedures between reserving UEs will not successfully resolve a conflict between overlapping reserved resources. As such, techniques described herein may enable a third-party UE (e.g., non-reserving UE) to identify overlapping resources reserved by other UEs (e.g., reserving UEs), and to determine that LBT procedures are unlikely to resolve the identified conflict. In such cases, the third-party UE (e.g., non-reserving UE) may transmit an indication of the conflict to at least one of the reserving UEs to instruct the reserving UE to reselect a new resource, thereby avoiding the conflict.

A method for wireless communication at a first UE is described. The method may include receiving, from a second UE, a first sidelink control message indicating a first reserved resource to be used by the second UE for sidelink communications in a shared radio frequency spectrum band, receiving, from a third UE, a second sidelink control message indicating a second reserved resource to be used by the third UE for sidelink communications in the shared radio frequency spectrum band, and transmitting an indication of a conflict between the first reserved resource indicated by the first sidelink control message and the second reserved resource indicated by the second sidelink control message based on the first reserved resource overlapping with the second reserved resource in time and frequency, a signal strength for a signal received from the second UE, the third UE or both, and at least one channel access parameter for communications with the second UE, the third UE or both.

An apparatus for wireless communication at a first UE is described. The apparatus may include a processor, memory coupled with the processor, and instructions stored in the memory. The instructions may be executable by the processor to cause the apparatus to receive, from a second UE, a first sidelink control message indicating a first reserved resource to be used by the second UE for sidelink communications in a shared radio frequency spectrum band, receive, from a third UE, a second sidelink control message indicating a second reserved resource to be used by the third UE for sidelink communications in the shared radio frequency spectrum band, and transmit an indication of a conflict between the first reserved resource indicated by the first sidelink control message and the second reserved resource indicated by the second sidelink control message based on the first reserved resource overlapping with the second reserved resource in time and frequency, a signal strength for a signal received from the second UE, the third UE or both, and at least one channel access parameter for communications with the second UE, the third UE or both.

Another apparatus for wireless communication at a first UE is described. The apparatus may include means for receiving, from a second UE, a first sidelink control message indicating a first reserved resource to be used by the second UE for sidelink communications in a shared radio frequency spectrum band, means for receiving, from a third UE, a second sidelink control message indicating a second reserved resource to be used by the third UE for sidelink communications in the shared radio frequency spectrum band, and means for transmitting an indication of a conflict between the first reserved resource indicated by the first sidelink control message and the second reserved resource indicated by the second sidelink control message based on the first reserved resource overlapping with the second reserved resource in time and frequency, a signal strength for a signal received from the second UE, the third UE or both, and at least one channel access parameter for communications with the second UE, the third UE or both.

A non-transitory computer-readable medium storing code for wireless communication at a first UE is described. The code may include instructions executable by a processor to receive, from a second UE, a first sidelink control message indicating a first reserved resource to be used by the second UE for sidelink communications in a shared radio frequency spectrum band, receive, from a third UE, a second sidelink control message indicating a second reserved resource to be used by the third UE for sidelink communications in the shared radio frequency spectrum band, and transmit an indication of a conflict between the first reserved resource indicated by the first sidelink control message and the second reserved resource indicated by the second sidelink control message based on the first reserved resource overlapping with the second reserved resource in time and frequency, a signal strength for a signal received from the second UE, the third UE or both, and at least one channel access parameter for communications with the second UE, the third UE or both.

Some examples of the method, apparatuses, and non-transitory computer-readable medium described herein may further include operations, features, means, or instructions for determining that the conflict exists based on the first reserved resource being within a first channel occupancy time (COT) associated with the second UE, shared with the second UE, or both, and based on the second reserved resource being within a second COT associated with the third UE, shared with the third UE, or both, where the at least one channel access parameter includes a COT parameter.

Some examples of the method, apparatuses, and non-transitory computer-readable medium described herein may further include operations, features, means, or instructions for determining that the conflict exists based on a first channel access type associated with the first reserved resource being a same channel access type as a second channel access type associated with the second reserved resource, where the at least one channel access parameter includes a channel access type parameter.

Some examples of the method, apparatuses, and non-transitory computer-readable medium described herein may further include operations, features, means, or instructions for determining that the conflict exists based on a first cyclic prefix extension (CPE) associated with the first reserved resource being a same CPE as a second CPE associated with the second reserved resource, where the at least one channel access parameter includes a CPE parameter.

Some examples of the method, apparatuses, and non-transitory computer-readable medium described herein may further include operations, features, means, or instructions for determining that the conflict exists based on the first reserved resource being within a first COT associated with the second UE, shared with the second UE, or both, and based on the second reserved resource being within a second COT associated with the third UE, shared with the third UE, or both, and based on a first CPE associated with the first reserved resource being a same CPE as a second CPE associated with the second reserved resource, where the at least one channel access parameter includes a COT parameter and a CPE parameter.

Some examples of the method, apparatuses, and non-transitory computer-readable medium described herein may further include operations, features, means, or instructions for determining that the conflict exists based on a first channel access type associated with the first reserved resource being a same channel access type as a second channel access type associated with the second reserved resource, and based on a first CPE associated with the first reserved resource being a same CPE as a second CPE associated with the second reserved resource, where the at least one channel access parameter includes a channel access type parameter and a CPE parameter.

Some examples of the method, apparatuses, and non-transitory computer-readable medium described herein may further include operations, features, means, or instructions for determining that the conflict exists based on a quantity of conflicting resources satisfying a quantity threshold, where the quantity of conflicting resources may be identified based on, for each respective resource of a set of multiple resources for a set of multiple UEs coordinated by the first UE, whether a signal strength for a signal received on the respective resource satisfies a signal strength threshold.

Some examples of the method, apparatuses, and non-transitory computer-readable medium described herein may further include operations, features, means, or instructions for determining that the conflict between the first reserved resource and the second reserved resource exists based on a first signal strength associated with a first signal received from the second UE satisfying a signal strength threshold.

Some examples of the method, apparatuses, and non-transitory computer-readable medium described herein may further include operations, features, means, or instructions for determining that the conflict between the first reserved resource and the second reserved resource exists based on a difference between the first signal strength associated with the first signal received from the second UE and a second signal strength associated with a second signal received from the third UE satisfying a signal strength difference threshold.

Some examples of the method, apparatuses, and non-transitory computer-readable medium described herein may further include operations, features, means, or instructions for transmitting the indication of the conflict to the second UE based on a first transmission of the second UE indicated by the first sidelink control message having a lower priority than a second transmission of the third UE indicated by the second sidelink control message.

Some examples of the method, apparatuses, and non-transitory computer-readable medium described herein may further include operations, features, means, or instructions for receiving, from the second UE responsive to the indication of the conflict, a third sidelink control message identifying a third reserved resource different from the first reserved resource to be used by the second UE for sidelink communications.

Some examples of the method, apparatuses, and non-transitory computer-readable medium described herein may further include operations, features, means, or instructions for receiving, from the second UE, capability signaling via a sidelink control information (SCI) message indicating that the second UE may be capable of receiving the indication of the conflict and transmitting the indication of the conflict to the second UE via a physical sidelink feedback channel based on receiving the capability signaling.

### BRIEF DESCRIPTION OF THE DRAWINGS

FIG. 1 illustrates an example of a wireless communications system that supports techniques for channel access-aware conflict determination for unlicensed sidelink bands in accordance with one or more aspects of the present disclosure.

FIG. 2 illustrates an example of a wireless communications system that supports techniques for channel access-aware conflict determination for unlicensed sidelink bands in accordance with one or more aspects of the present disclosure.

FIG. 3 illustrates an example of resource configurations that support techniques for channel access-aware conflict determination for unlicensed sidelink bands in accordance with one or more aspects of the present disclosure.

FIG. 4 illustrates an example of resource configurations that support techniques for channel access-aware conflict determination for unlicensed sidelink bands in accordance with one or more aspects of the present disclosure.

FIG. 5 illustrates an example of a resource configuration that supports techniques for channel access-aware conflict determination for unlicensed sidelink bands in accordance with one or more aspects of the present disclosure.

FIG. 6 illustrates an example of resource configurations that support techniques for channel access-aware conflict determination for unlicensed sidelink bands in accordance with one or more aspects of the present disclosure.

FIG. 7 illustrates an example of a resource configuration that supports techniques for channel access-aware conflict determination for unlicensed sidelink bands in accordance with one or more aspects of the present disclosure.

FIG. 8 illustrates an example of a process flow that supports techniques for channel access-aware conflict determination for unlicensed sidelink bands in accordance with one or more aspects of the present disclosure.

FIGS. 9 and 10 show block diagrams of devices that support techniques for channel access-aware conflict determination for unlicensed sidelink bands in accordance with one or more aspects of the present disclosure.

FIG. 11 shows a block diagram of a communications manager that supports techniques for channel access-aware conflict determination for unlicensed sidelink bands in accordance with one or more aspects of the present disclosure.

FIG. 12 shows a diagram of a system including a device that supports techniques for channel access-aware conflict determination for unlicensed sidelink bands in accordance with one or more aspects of the present disclosure.

FIGS. 13 through 16 show flowcharts illustrating methods that support techniques for channel access-aware conflict determination for unlicensed sidelink bands in accordance with one or more aspects of the present disclosure.

### DETAILED DESCRIPTION

In some wireless communications, wireless devices (e.g., UEs) may be able to communicate with one another directly using sidelink communications. Different mechanisms may be employed to reduce interference in sidelink bands. In some cases, UEs may exchange inter-UE coordination messages to reserve resources for sidelink communications. In other cases, UEs may perform listen-before-talk (LBT) procedures to reduce interference. However, current techniques for reducing interference in sidelink bands may still result in interference.

Some wireless communications systems have enabled UEs to reserve resources in unlicensed sidelink bands using inter-UE coordination messages in an attempt to reduce interference within the unlicensed bands. In such cases, a UE may reserve resources within the unlicensed sidelink band, and may subsequently perform an LBT procedure to ensure that the UE is able to use the previously-reserved sidelink resources. However, in some cases, the UE may fail to clear the LBT procedure (e.g., due to detected sidelink resources from other UEs), and may therefore be unable to use the previously-reserved resources. In such cases, the combination of inter-UE coordination messages and LBT procedures may result in wasted sidelink resources. Moreover, in some implementations, two separate UEs may reserve the same resources using inter-UE coordination messages, and may both successfully clear respective LBT procedures (despite the overlapping reserved resources). In such cases, the LBT procedures may not successfully resolve the conflict, and may result in increased interference within the sidelink band.

Accordingly, aspects of the present disclosure are directed to techniques for channel access-aware conflict determination for unlicensed sidelink bands. Generally, the described techniques provide for configurations and conditions which enable UEs to determine whether conflicts exist between reserved resources in unlicensed sidelink bands based on one or more channel access parameters. In some cases, the channel access parameters may be used to determine a relative probability that LBT procedures between reserving UEs will not successfully resolve a conflict between overlapping reserved resources. Channel access procedures that may be used to determine conflicts between reserved resources may include, but are not limited to, channel occupancy time (COT) parameters (e.g., whether reserved resources fall within a COT of the reserving UE), channel access type parameters (e.g., what types of LBT procedures will be performed to resolve conflicts), cyclic prefix extension (CPE) parameters (e.g., when transmissions within the conflicting reserved resources are scheduled to begin), and the like.

As such, techniques described herein may enable a third-party UE (e.g., non-reserving UE) to identify overlapping resources reserved by other UEs (e.g., reserving UEs), and to determine that LBT procedures are unlikely to resolve the identified conflict. In such cases, the third-party UE (e.g., non-reserving UE) may transmit an indication of the conflict to at least one of the reserving UEs to instruct the reserving UE to reselect a new resource, thereby avoiding the conflict. By evaluating channel access parameters to determine whether a conflict exists, the third-party UE may be able to determine whether LBT procedures performed at the reserving UEs are likely to resolve the conflict, or determine whether the third-party UE should transmit a message indicating the conflict to enable one of the UEs to select a new resource to avoid the conflict.

Aspects of the disclosure are initially described in the context of wireless communications systems. Additional aspects of the disclosure are described in the context of example resource configurations and an example process flow. Aspects of the disclosure are further illustrated by and described with reference to apparatus diagrams, system diagrams, and flowcharts that relate to techniques for channel access-aware conflict determination for unlicensed sidelink bands.

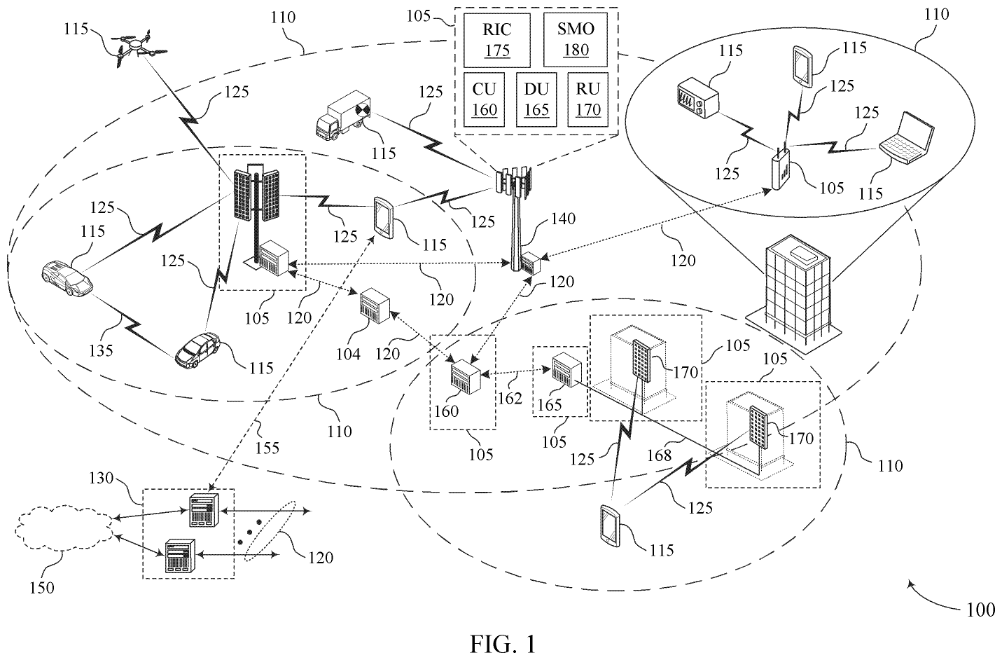

FIG. 1 illustrates an example of a wireless communications system 100 that supports techniques for channel access-aware conflict determination for unlicensed sidelink bands in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for channel access-aware conflict determination for unlicensed sidelink bands as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which (Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Accordingly, wireless devices of the wireless communications system 100 may be configured to support techniques for channel access-aware conflict determination for unlicensed sidelink bands. Generally, the wireless communications system 100 may support signaling, configurations, and conditions which enable UEs 115 and other wireless devices (e.g., IAB nodes) to determine whether conflicts exist between reserved resources in unlicensed sidelink bands based on one or more channel access parameters. In some cases, the channel access parameters may be used to determine a relative probability that LBT procedures between reserving UEs 115 will not successfully resolve a conflict between overlapping reserved resources.

Channel access procedures that may be used to determine conflicts between reserved resources may include, but are not limited to, COT parameters (e.g., whether reserved resources fall within a COT of the reserving UE), channel access type parameters (e.g., what types of LBT procedures will be performed to resolve conflicts), CPE parameters (e.g., when transmissions within the conflicting reserved resources are scheduled to begin), and the like.

For example, a first UE 115 may receive a first sidelink control information (SCI) message from a second UE 115 which reserves a first resource of a shared frequency band (e.g., unlicensed sidelink band). The first UE 115 may also receive a second SCI message from a third UE 115 which reserves a second resource of the shared frequency band, where the first and second resources overlap in time and frequency. In this example, the first UE 115 may determine whether a conflict exists between the overlapping first and second resources based on a signal strength associated with signals received from the second and/or third UEs 115, and based on one or more channel access parameters. If a conflict exists, the first UE 115 may transmit an indication of the identified conflict to the second UE 115 or the third UE 115 with the lower-priority communication so that the respective UE 115 can select a new resource to avoid the conflict, and reduce interference within the shared radio frequency band.

In particular, the first UE 115 may evaluate channel access parameters to determine whether LBT procedures performed at the second and third UEs 115 are likely to resolve the potential conflict between resources. If the channel access parameters suggest that LBT procedures are likely to resolve the potential conflict, the first UE 115 may determine that no conflict exists, and may refrain from transmitting a conflict indication. Conversely, if the channel access parameters suggest that LBT procedures are unlikely to resolve the potential conflict, the first UE 115 may transmit an indication of the identified conflict to reduce interference within the shared radio frequency band.

Techniques described herein may enable UEs 115 to identify and resolve potential conflicts within a shared radio frequency band, such as an unlicensed sidelink band. In particular, techniques described herein may utilize channel access parameters associated with sidelink communications between devices in order to determine a relative likelihood that LBT procedures will resolve potential conflicts. In this regard, techniques described herein may enable UEs1 115 to determine whether conflicts exist, and whether the UEs 115 are expected to transmit conflict indications to help avoid the conflict. As such, aspects of the present disclosure may reduce interference and noise within shared radio frequency bands, and may lead to more efficient resource utilization within the shared radio frequency bands.

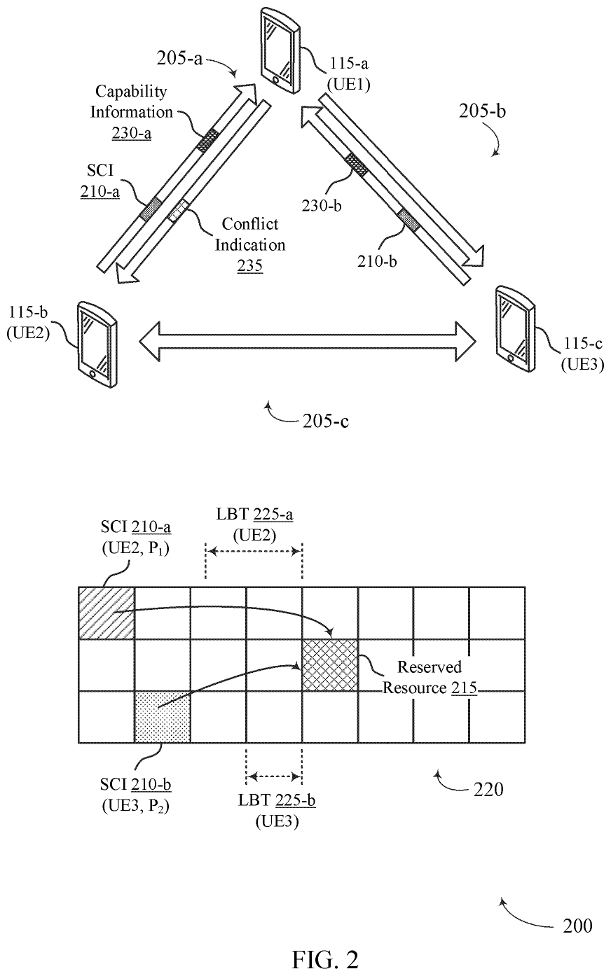

FIG. 2 illustrates an example of a wireless communications system 200 that supports techniques for channel access-aware conflict determination for unlicensed sidelink bands in accordance with one or more aspects of the present disclosure. In some examples, wireless communications system 200 may implement aspects of wireless communications system 100.

The wireless communications system 200 may include a first UE 115-a, a second UE 115-b, and a third UE 115-c, which may each be an example of a UE 115 described with reference to FIG. 1. The UEs 115 may communicate with one another directly on respective wireless channels of the wireless communications system 200. For example, the first UE 115-a and the second UE 115-b may communicate on via a first sidelink channel 205-a. Similarly, the first UE 115-a and the third UE 115-c may communicate using a second sidelink channel 205-b, and the second UE 115-b and the third UE 115-c may communicate using a third sidelink channel 205-c.

In some cases, the sidelink channels 205 may include resources associated with a physical sidelink control channel (PSCCH), a physical sidelink shared channel (PSSCH), a physical sidelink feedback channel (PSFCH), or any combination thereof. Moreover, in some cases, the sidelink channels 205 may be associated with licensed sidelink bands, unlicensed sidelink bands (e.g., shared radio frequency bands), or both.

As noted previously herein, in some implementations, UEs 115 may be configured to exchange inter-UE coordination information (e.g., inter-UE coordination messages) associated with resource conflicts within a set of resources, such as a licensed radio frequency band. For example, in the context of inter-UE coordination scheme 2, the second UE 115-b may be configured to transmit an SCI message to reserve resources for sidelink communications. In this example, the first UE 115-a may be configured to transmit, to the second UE 115-b, inter-UE coordination information associated with resource conflicts that the second UE 115-b has reserved, such as when the resources reserved by the second UE 115-b overlap with resources reserved by another UE 115.

Stated differently, the first UE 115-a may indicate expected resource conflicts with resources reserved by the second UE 115-b. In such cases, the first UE 115-a may be the recipient of at least one transport block associated with the conflicting reservations. Moreover, whether the non-destination UE 115 of a transport block transmitted by the second UE 115-b can be the first UE 115-a may be configured by an RRC parameter (e.g., RRC parameter sl-TypeUE-A).

Continuing with reference to inter-UE coordination scheme 2, the first UE 115-a may be configured to identify conflicts between resources reserved by other UEs 115. A conflict may arise in several scenarios. For example, in some cases, the second UE 115-b may reserve a resource that overlaps with a resource reserved by the third UE 115-c. In such cases, the first UE 115-a may identify a conflict between the overlapping resources if one or more conditions are met. In some aspects, which condition is used to determine the existence of a conflict may be configured via RRC signaling (e.g., RRC signaling from the network, from a UE 115, etc.).

Using a first condition (Condition A), a conflict may arise when the RSRP measurement of a transmission (e.g., SCI) from the second UE 115-b to the first UE 115-a is above a threshold. For instance, if the first UE 115-a is an intended receive for a PSSCH message in a resource reserved by the second UE 115-b, the first UE 115-a may determine a conflict using the first condition if the RSRP of a transmission received from the third UE 115-c is above a threshold. Similarly, if the first UE 115-a is an intended receiver for a PSSCH message in a resource reserved by the third UE 115-c, the first UE 115-a may determine a conflict if the RSRP of a transmission received from the second UE 115-b is above a threshold. In some aspects, the threshold (thresh(p₁, p₂)) may be configured via RRC signaling.

Using a second condition (Condition B), a conflict may arise when a difference in RSRP measurements between conflicting transmissions (e.g., SCIs) of the second UE 115-b and the third UE 115-b is above a threshold. For instance, if the first UE 115-a is an intended receiver for a PSSCH message in a resource reserved by the second UE 115-b, the first UE 115-a may determine a resource conflict if RSRP₂>RSRP₁+Δ_{Th}, where RSRP₁ and RSRP₂ are the RSRP measurements from signals received by the first UE 115-a from the second UE 115-b and the third UE 115-c, respectively, and where Δ_{Th} may be configured via RRC. Similarly, if the first UE 115-a is an intended receiver for a PSSCH message in a resource reserved by the third UE 115-c, the first UE 115-a may determine a resource conflict if RSRP₁>RSRP₂+Δ_{Th}.

In additional or alternative implementations, a conflict may arise when the first UE 115-a has a half-duplex conflict in the slot where the second UE 115-b is scheduled to perform a transmission. In other words, the first UE 115-a may determine the existence of a conflict when resources reserved by the second UE 115-b overlap with resources previously reserved by the first UE 115-a.

In cases where the first UE 115-a identifies a conflict between resources reserved by other UEs 15-b, 115-c, the first UE 115-a may transmit a conflict indicator to the UE 115 with the lower-priority transmission. In some aspects the ability of UEs 115 to receive conflict indicators may be signaled via SCI-1, if pre-configured. That is, the UEs 115 may indicate to one another whether they are capable of receiving messages indicating resource conflicts (e.g., capable of receiving inter-UE coordination messages indicating resource conflicts).

For example, the second UE 115-b may reserve a resource for a sidelink transmission with priority p₁, and the third UE 115-c may reserve a resource for a sidelink transmission with priority p₂, where p₂>p₁. In this example, if the first UE 115-a identifies a conflict between the resources, the first UE 115-a may transmit a conflict indicator (e.g., via PSFCH message) to the second UE 115-b, as the second UE 115-b is associated with the lower-priority transmission. In this regard, the first UE 115-a may instruct/request that the second UE 115-b select a new resource for the sidelink transmission.

Upon receiving a PSFCH message including a conflict indication, the second UE 115-b may determine a presence of the resource conflict based on conflict information in the PSFCH message, and the second UE 115-b may report the resource conflict to higher layers. If slotLevelResourceExclusionScheme2 is not provided, the second UE 115-b may be configured to report resources overlapping with a next in time reserved resource indicated by the SCI format 1-A (time-frequency resource collision). Comparatively, slotLevelResourceExclusionScheme2 is provided, the second UE 115-b may be configured to report resources in a slot of a next in time reserved resource indicated by the SCI format 1-A (half-duplex). In this example, the MAC layer at the second UE 115-b may reselect the reported resources from the resources indicated by PHY layer, excluding the reported resources (e.g., select a new resource that does not include the conflicting resource).

Another example for the inter-UE coordination scheme 2 may prove to be illustrative. In this example, the first UE 115-a may determine which (if any) UE 115 to transmit conflict information to via a PSFCH message according to the following. First, if, for a resource pool, typeAUEScheme2 is disabled, the first UE 115-a has been indicated a first reserved resource and a second reserved resource as resources for PSSCH reception or, if for a resource pool typeAUEScheme2 is enabled, has been indicated at least the first reserved resource or the second reserved resource for PSSCH reception.

Continuing with the same example, the first UE 115-a may detect a first SCI message (e.g., SCI format 1-A) from the second UE 115-b that includes a first priority value p₁, where the first SCI message indicates a reserved resource for a PSSCH transmission from the second UE 115-b. Similarly, the first UE 115-a may detect a second SCI message (e.g., SCI format 1-A) from the third UE 115-c that includes a second priority value p₂, where the second SCI message indicates a reserved resource for a PSSCH transmission from the third UE 115-c. Subsequently, the first UE 115-a may determine that the first and second resources overlap in time and frequency, and that the PSFCH occasions for resource conflict information of the second UE 115-b and the third UE 115-c are valid. The indicationUEB flag in SCI Format 1-A from the second UE 115-b and the third UE 115-c may be set to 1, if indicationUEBScheme2=‘enabled.’ Moreover, the first UE 115-a may determine the first SCI format 1-A and the second SCI format 1-A are not received later than sl-MinTimeGapPSFCH before the PSFCH occasion for conflict information. In this example, the first UE 115-a may transmit conflict information via a PSFCH transmission to the second UE 115-b if p₂>p₁, and may transmit conflict information via a PSFCH transmission to the second UE 115-b or the third UE 115-c if p₂=p₁.

Additional or alternative techniques may be used in an attempt to reduce interference on shared or unlicensed sidelink bands. For example, in some cases, the wireless communications system 200 may support sidelink communications on unlicensed spectrum (e.g., shared radio frequency bands). Unlicensed spectrum may be shared by other technologies (e.g., Wi-Fi), and access to the unlicensed spectrum may be subject to regulatory requirements. For example, in some cases, devices (e.g., UEs 115-) may be required to perform an LBT procedure before communicating on the unlicensed spectrum, in which the device performs sensing (e.g., listen) before the device is able to transmit (e.g., talk) over the unlicensed spectrum.

During an LBT procedure, a device may measure energy within the monitored radio frequency band, and may be able to access the spectrum (e.g., transmit over the band) if measured energy is below some threshold. In other words, in the context of unlicensed/shared spectrum, devices may be required to determine that the band is not in use before the devices are able to transmit over the band.

There are different types of LBT procedures, including CAT 2 LBT procedures and CAT 4 LBT procedures. In accordance with a CAT 2 LBT procedure, a device may perform LBT without random back-off, in which the device performs channel sensing for a respective radio frequency band with a fixed sensing duration (e.g., without random back-off). Comparatively, in accordance with a CAT 4 LBT procedure, a device may perform LBT with random back-off with a contention window of variable size (e.g., channel sensing duration is random or variable). In some cases, the sensing duration may be shorter in CAT 2 LBT compared to CAT 4 (e.g., easier to access channel in CAT 2 compared to CAT 4).

As such, the different types of LBT (e.g., CAT 2, CAT 4) may be used in different circumstances, such as based on whether the transmission is in a COT or outside a COT. For in-COT transmission, either CAT2 LBT or no LBT may be used based on the gap between the transmissions. Comparatively, for out-of-COT transmissions, CAT 4 LBT procedures may be used.

As noted previously herein, some wireless communications systems enable UEs 115 to reserve resources in unlicensed sidelink bands using inter-UE coordination messages in an attempt to reduce interference within the unlicensed bands. In such cases, a UE 115 may reserve resources within the unlicensed sidelink band, and may subsequently perform an LBT procedure to ensure that the UE 115 is able to use the previously-reserved sidelink resources. In other words, in the context of sidelink communications over an unlicensed band (e.g., shared radio frequency band), in cases were a UE 115 has successfully selected resources and broadcast a resource reservation via SCI (e.g., SCI-1), the UE 115 may potentially fail to clear the LBT for channel access for the future reserved resources, and may therefore be unable to use the previously-reserved resources. Considering the potential LBT failure in unlicensed band, collision may or may not occur on the overlapping reserved resources. As such, previous conflict-determination/resolution techniques described herein (e.g., inter-UE scheme 2) may result in unnecessary resource reselection within unlicensed bands.

For example, as shown in FIG. 2, the second UE 115-b may transmit a first SCI message 210-a to the first UE 115-a, where the first SCI message 210-a reserves a resource 215 for a first sidelink message within an unlicensed band (e.g., shared radio frequency spectrum 220). Similarly, the third UE 115-c may transmit a second SCI message 210-b to the first UE 115-a, where the second SCI message 210-b reserves a resource 215 for a second sidelink message within an unlicensed band. In this example, the resources 215 reserved by the UEs 115-b, 115-c may be the same, or may at least partially overlap in the time and frequency domains. Moreover, the SCI messages 210-a, 210-b may indicate priorities p₁, p₂ associated with the scheduled sidelink messages.

In this example, even though the resources 215 reserved by both the second UE 115-b and the third UE 115-c overlap with one another, a resource conflict may or may not exist or actually take place depending on whether the resource conflict is in-COT or out-of-COT. For example, if the resource 215 is located outside of a COT for both UEs 115-b, 115-c (e.g., both out-COT), LBT randomization may reduce the collision probability. Moreover, in cases where the scheduled sidelink messages are low-priority in-COT and high-priority out-COT (and/or high-priority in-COT and low-priority out-COT), different LBT types may reduce collision probability within the overlapping resources 215. In particular, if the second UE 115-b performs an LBT procedure 225-a, and the third UE 115-b performs an LBT procedure 225-b, one of the UEs 115-b, 115-c is likely to fail LBT before the reserved resource 215, thereby avoiding the conflict/collision within the resource 215.

Comparatively, if the resource 215 is in-COT for both UEs 115-b, 115-c, the collision probability may be high since the same LBT type may be used. In other words, if both are in-COT, the UEs 115-b, 115-c, may perform the same LBT procedures (e.g., listen at the same time), and may therefore fail to identify the conflicting resources 215.

Stated differently, even though the resources 215 reserved by both UEs 115-b, 115-c overlap with one another, the relative probability that a conflict/collision will actually occur within the resource may depend on a number of factors/parameters, including the types of LBT procedures 225 to be performed (e.g., time durations for LBT procedures 225), whether the resource is in-COT or out-COT for the respective UEs 115, and the like.

As such, according to some aspects of the present disclosure, in cases where the resources 215 overlap with one another, but the overlap is unlikely to result in a collision (as one of the UEs 115-b, 115-c is likely to fail LBT), the UE 115-a may determine that an actual conflict does not exist (or is otherwise unlikely to result in a collision), and therefore the first UE 115-a may refrain from transmitting a conflict indication.

Aspects of the present disclosure are directed to techniques for channel access-aware conflict determination for unlicensed sidelink bands. Generally, the described techniques provide for configurations and conditions which enable UEs 115 to determine whether conflicts exist between reserved resources in unlicensed sidelink bands based on one or more channel access parameters. In some cases, the channel access parameters may be used to determine a relative probability that LBT procedures between reserving UEs 115 will not successfully resolve a conflict between overlapping reserved resources.

For example, as shown in FIG. 2, the first UE 115-a may receive, from the second UE 115-b, the third UE 115-c, or both, capability information 230-a, 230-b which indicates whether the second UE 115-b and/or third UE 115-c are capable of receiving conflict indications 235. In some cases, the capability information 230 may be communicated via SCI messages 210. In other words, the UEs 115-b, 115-c may broadcast or otherwise indicate whether the UEs 115-b, 115-c are capable of receiving inter-UE coordination messages (e.g., PSFCH messages, SCI messages 210) indicating resource conflicts.

The first UE 115-a may receive a first SCI message 210-a from the second UE 115-b, where the first SCI message 210-a indicates a first reserved resource 215 to be used by the second UE 115-b for sidelink communications within the shared radio frequency spectrum 220 (e.g., unlicensed band). In some cases, the first SCI message 210-a may indicate a first priority (p₁) associated with the first reserved resource 215, the sidelink communications scheduled to be performed within the first resource 215, the second UE 115-b, or any combination thereof.

Similarly, the first UE 115-a may receive a second SCI message 210-b from the third UE 115-c, where the second SCI message 210-b indicates a second reserved resource 215 to be used by the third UE 115-c for sidelink communications within the shared radio frequency spectrum 220. As shown in FIG. 2, the second resource 215 may be the same as the first resource 215 reserved by the second UE 115-b, or may at least partially overlap in time and frequency with the first reserved resource 215 reserved by the second UE 115-b. In some cases, the second SCI message 210-b may indicate a second priority (p₂) associated with the second resource 215, the sidelink communications scheduled to be performed within the second resource 215, the third UE 115-c, or any combination thereof.

In some aspects the first UE 115-a may determine whether or not a conflict exists between the first resource 215 reserved by the second UE 115-b and the second resource 215 reserved by the third UE 115-c. In particular, the first UE 115-a may determine whether or not a conflict exists based on whether the overlapping resources 215 are likely to result in a collision or be resolved via LBT procedures at the respective UEs 115-b, 115-c. In this regard, the first UE 115-a may determine whether or not a conflict exists based on receiving the first SCI message 210 at 810, receiving the second SCI message 210 at 815, or both.

In some aspects, the first UE 115-a may determine whether a conflict exists based on the first resource 215 and the second resource 215 at least partially overlapping with one another in time and frequency. Additionally, the first UE 115-a may determine whether a conflict exists based on a signal strength associated with signals (e.g., SCI messages 210) received from the second UE 115-b, the third UE 115-c, or both.

Further, the first UE 115-a may determine whether a conflict exists based on one or more additional channel access parameters associated with communications at/with the second UE 115-b, the third UE 115-c, or both. Channel access parameters used for performing conflict determination may include, but are not limited to, COT parameters (e.g., whether the reserved resources 215 fall within a COT of the respective UEs 115-b, 115-c), channel access type parameters (e.g., what types of LBT procedures will be performed by the UEs 115-b, 115-c), CPE parameters (e.g., when transmissions within the conflicting reserved resources 215 are scheduled to begin), and the like. As described previously herein, channel access parameters may be used by the first UE 115-a to determine a relative likelihood or probability that overlapping resources are likely to result in a collision (e.g., relative probability that LBT procedures will resolve the potential conflict prior to collision).

For example, the first UE 115-a may determine whether or not a conflict exists based on a COT parameter associated with the second UE 115-b, the third UE 115-c, or both. In this example, the first UE 115-a may determine that a conflict exists if the first resource 215 reserved by the second UE 115-b is in a COT associated with (or shared to/with) the second UE 115-b, and if the second resource 215 reserved by the third UE 115-c is in a COT associated with (or shared to/with) the third UE 115-c. In other words, if at least one of the first resource 215 or the second resource 215 is not within a COT of the respective corresponding UE 115-b, 115-c, the first UE 115-a may be configured to determine that no conflict exists (or that LBT procedures performed at the respective UEs 115-b, 115-c are likely to resolve the potential conflict prior to collision).

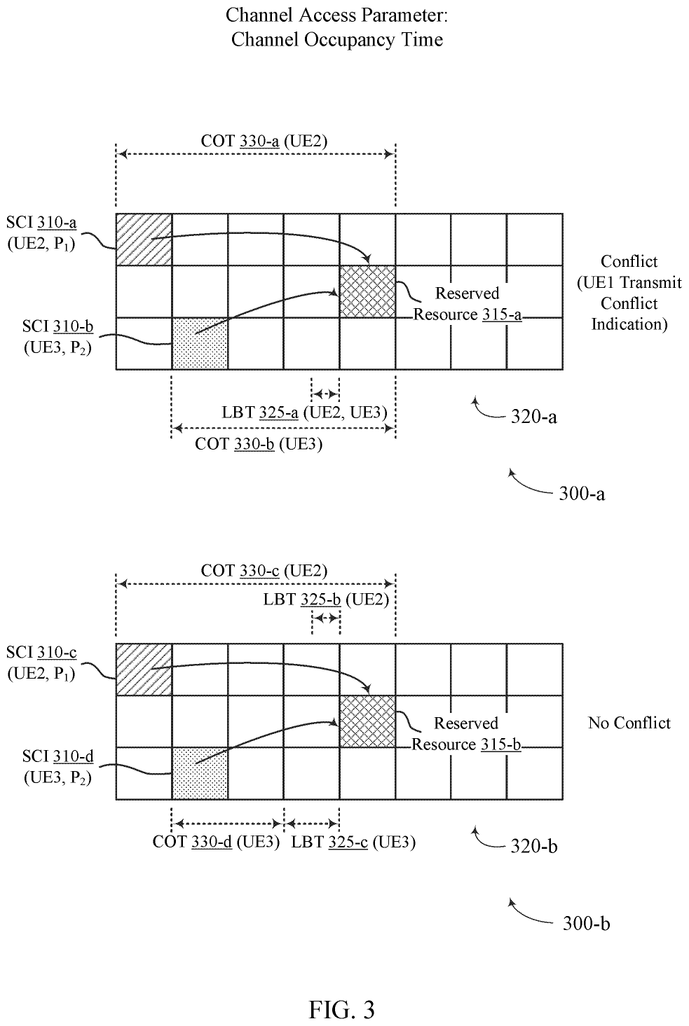

Conflict determination based on COT parameter(s) will be further shown and described with reference to FIG. 3.

By way of another example, in some cases, the first UE 115-a may determine whether or not a conflict exists based on a channel access type parameter associated with the second UE 115-b, the third UE 115-c, or both. In this example, the first UE 115-a may determine that a conflict exists if first resource 215 reserved by the second UE 115-b and the second resource 215 reserved by the third UE 115-c are associated with a same channel access type (e.g., both CAT 2 16 ms, both CAT 2 25 ms, both CAT 4, etc.). In other words, if the first channel access type associated with the first resource 215 reserved by the second UE 115-b and the second channel access type associated with the second resource 215 reserved by the third UE 115-c are different, the first UE 115-a may be configured to determine that no conflict exists (or that LBT procedures performed at the respective UEs 115-b, 115-c are likely to resolve the potential conflict prior to collision).

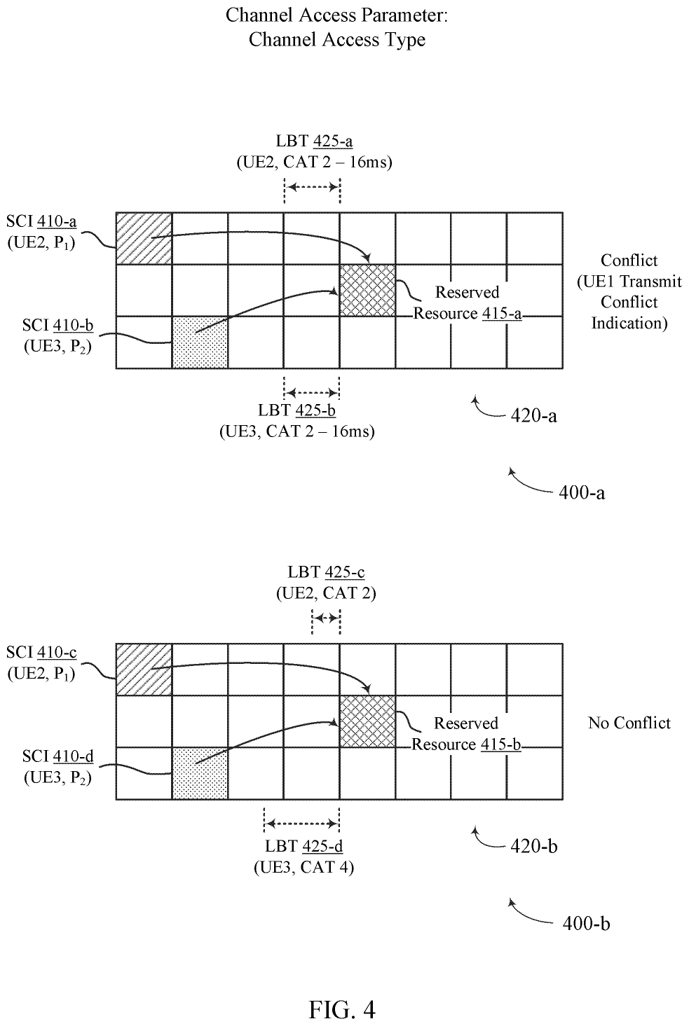

Conflict determination based on channel access type parameter(s) will be further shown and described with reference to FIG. 4.

By way of another example, in some cases, the first UE 115-a may determine whether or not a conflict exists based on a CPE parameter associated with transmissions to be performed by the second UE 115-b, the third UE 115-c, or both. In this example, the first UE 115-a may determine that a conflict exists if first resource 215 reserved by the second UE 115-b and the second resource 215 reserved by the third UE 115-c are associated with a same CPE. In other words, if a first CPE associated with the first resource and a second CPE associated with the second resource are different (e.g., transmissions within the resources are scheduled to begin at different times), the first UE 115-a may be configured to determine that no conflict exists (or that LBT procedures performed at the respective UEs 115-b, 115-c are likely to resolve the potential conflict prior to collision).

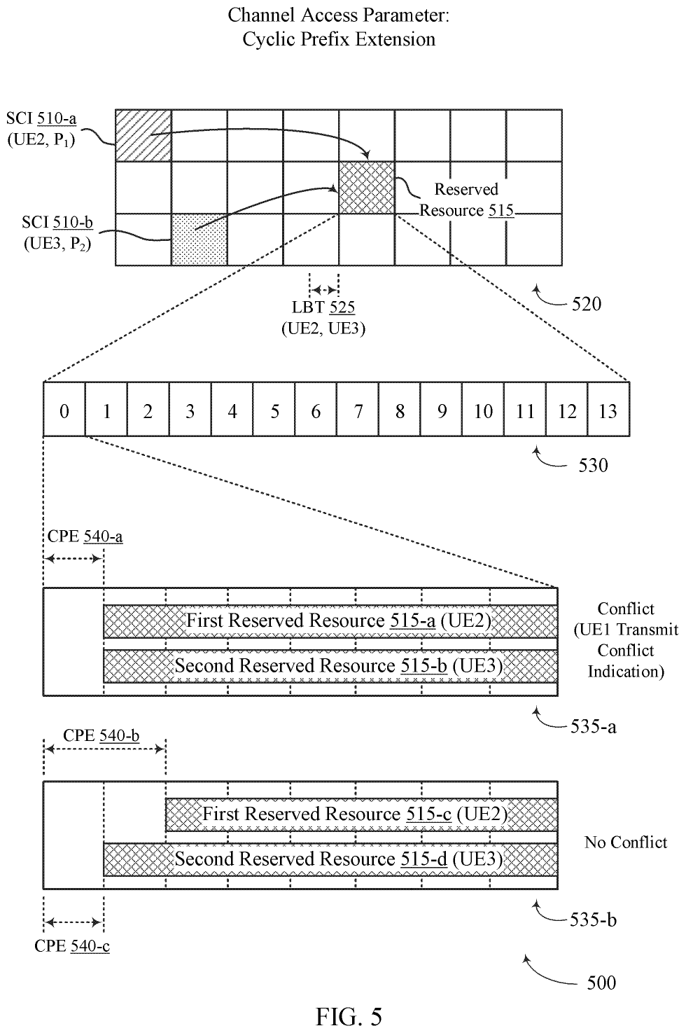

Conflict determination based on CPE parameter(s) will be further shown and described with reference to FIG. 5.

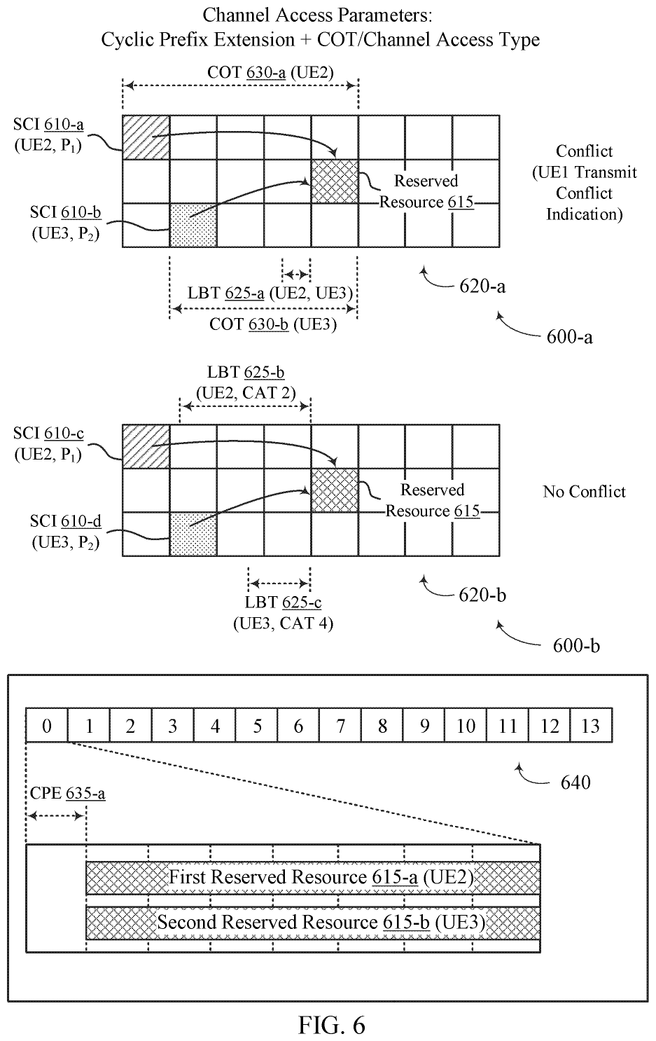

Moreover, in some cases, the first UE 115-a may be configured to evaluate whether or not a conflict exists based on one or more channel access parameters. Conflict determination based on multiple channel access parameter(s) will be further shown and described with reference to FIG. 6.

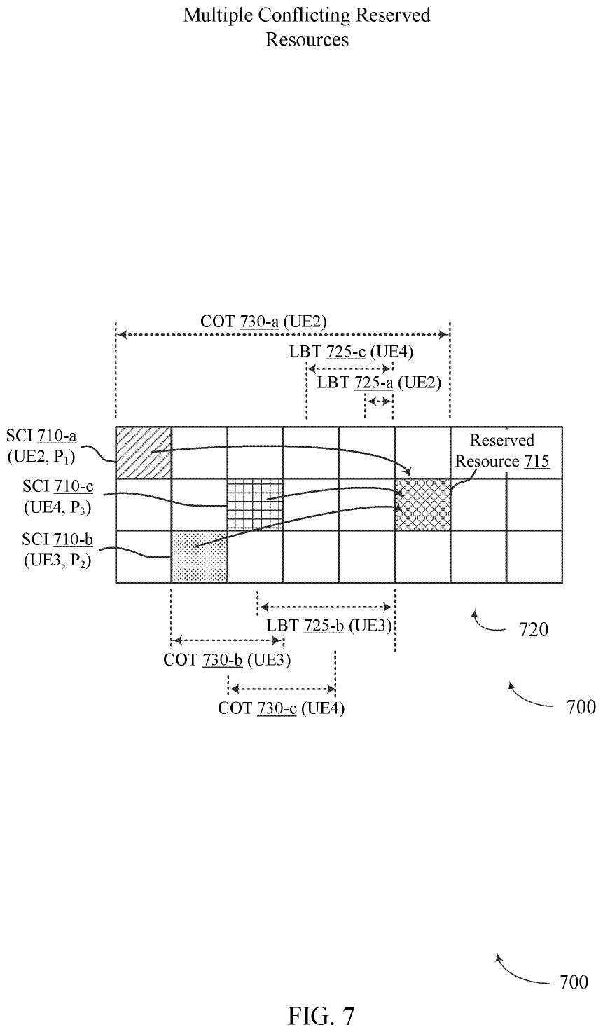

Further, in some cases, the first UE 115-a may be configured to evaluate whether or not a conflict exists based on how many overlapping resources there are (e.g., how many UEs 115 have reserved overlapping resources). Conflict determination based on a quantity of overlapping resources will be further shown and described with reference to FIG. 7.

In cases where the first UE 115-a determines that there is no conflict (or that the overlapping resources 215 are unlikely to result in a collision), the first UE 115-a may refrain from transmitting a conflict indication 235. Conversely, in cases where the first UE 115-a determines that there is a conflict (e.g., that overlapping resources 215 are likely to result in a collision), the first UE 115-a may transmit a conflict indication to one (or both) of the UEs 115-b, 115-c associated with the conflict.

For example, in cases where the first resource 215/transmission reserved or scheduled by the second UE 115-b is associated with a lower priority as compared to the second resource 215/transmission reserved or scheduled by the third UE 115-c (e.g., p₂>p₁) the first UE 115-a may transmit a conflict indication 235 to the second UE 115-b based on the second UE 115-b being associated with the lower priority. The conflict indication 235 may be transmitted via an SCI message 210, a PSFCH message, and the like.

Subsequently, the second UE 115-b may select a new resource (e.g., third resource) for performing the sidelink communications. In particular, the second UE 115-b may select a new resource based on receiving the conflict indication 235 from the first UE 115-a. In this regard, the conflict indication 235 may help the wireless devices to avoid collisions within the shared radio frequency spectrum 220.

Techniques described herein may enable UEs 115 to identify and resolve potential conflicts within a shared radio frequency spectrum 220, such as an unlicensed sidelink band. In particular, techniques described herein may utilize channel access parameters associated with sidelink communications between devices in order to determine a relative likelihood that LBT procedures will resolve potential conflicts. In this regard, techniques described herein may enable UEs1 115 to determine whether conflicts exist, and whether the UEs 115 are expected to transmit conflict indications 235 to help avoid the conflict. As such, aspects of the present disclosure may reduce interference and noise within shared radio frequency spectrum 220, and may lead to more efficient resource utilization within the shared radio frequency spectrum 220.

FIG. 3 illustrates an example of resource configurations 300-a, 300-b that support techniques for channel access-aware conflict determination for unlicensed sidelink bands in accordance with one or more aspects of the present disclosure. In some examples, aspects of the resource configurations 300 may implement, or be implemented by, aspects of the wireless communications system 100, the wireless communications system 200, or both.

In particular, the resource configurations 300 illustrate conflict determinations that may be performed at a first UE 115 (UE1) based on COT parameters (e.g., based on whether reserved resources are positioned within COTs of the reserving UEs 115).

For example, in some cases, a first UE 115 (UE1) may determine whether a resource conflict exists/occurs if the following conditions are satisfied: (1) a first resource (r₁) reserved by a second UE 115 (UE2) overlaps with a second resource (r₂) reserved by a third UE 115 (UE3), (2) Condition A and/or Condition B related to RSRP measurements of received transmissions described above are satisfied, and (3) the first reserved resource r₁ is within a COT associated with (or shared to/with) the second UE 115, and the second reserved resource r₂ is within a COT associated with (or shared to/with) the third UE 115.

In such cases, if the first UE 115 determines that a conflict exists based on the COT parameters (e.g., whether or not the reserved resources are within COTs associated with the respective UEs 115), the first UE 115 may transmit a conflict indication to the UE 115 (e.g., UE2, UE3) with the lower priority transmission.

In other words, if at least one of the first reserved resource r₁ and the second reserved resource r₂ is not within a COT of the corresponding UE 115 (or not within a shared COT to the corresponding UE 115), the first UE 115 may be configured to determine that no conflict exists, even if the remaining conditions (e.g., condition 1, condition 2 (Conditions A, B)) are satisfied.

For example, referring to the first resource configuration 300-a, the first UE 115 (UE1) may receive a first SCI message 310-a from a second UE 115 (UE2), where the first SCI message 310-a indicates a first reserved resource 315-a to be used by the second UE 115 for sidelink communications within a shared radio frequency spectrum 320-a (e.g., unlicensed band). In some cases, the first SCI message 310-a may indicate a first priority (p1) associated with the first reserved resource 315-a, the sidelink communications scheduled to be performed within the first resource 315-a, the second UE 115, or any combination thereof.

Similarly, the first UE 115 may receive a second SCI message 310-b from a third UE 115 (UE3), where the second SCI message 310-b indicates a second reserved resource 315-a to be used by the third UE 115 for sidelink communications within the shared radio frequency spectrum 320-a. As shown in FIG. 3, the second resource 315-a may be the same as the first resource 315-a reserved by the second UE 115, or may at least partially overlap in time and frequency with the first reserved resource 315-a reserved by the second UE 115. In some cases, the second SCI message 310-b may indicate a second priority (p₂) associated with the second resource 315-b, the sidelink communications scheduled to be performed within the second resource 315-b, the third UE 115, or any combination thereof.

In this example, the second UE 115 and the third UE 115 may be configured to perform a same LBT procedure 325-a prior to the reserved resources 315-a. Moreover, the reserved resources 315-a may be within a COT 330 associated with each of the respective UEs 115. In particular, the first resource 315-a reserved by the first SCI message 310-a is within a COT 330-a associated with (or shared to/with) the second UE 115 (UE2), and the second resource 315-a reserved by the second SCI message 310-b is within a COT 330-b associated with (or shared to/with) the third UE 115 (UE3). As such, because the resources 315-a reserved by the respective UEs 115 are positioned within COTs 330 associated with the respective UEs 115, the first UE 115 (UE1) may be configured to identify a conflict, and transmit a conflict indication to the UE 115 with the lower priority (e.g., transmit conflict indication to UE2 if p₁<p₂).

Comparatively, reference will now be made to the second resource configuration 300-b. As described previously herein, the first UE 115 (UE1) may receive a first SCI message 310-c from a second UE 115 (UE2), where the first SCI message 310-c indicates a first reserved resource 315-b to be used by the second UE 115 for sidelink communications within a shared radio frequency spectrum 320-b (e.g., unlicensed band). In some cases, the first SCI message 310-c may indicate a first priority (p₁) associated with the first reserved resource 315-b, the sidelink communications scheduled to be performed within the first resource 315-b, the second UE 115, or any combination thereof.

Similarly, the first UE 115 may receive a second SCI message 310-d from a third UE 115 (UE3), where the second SCI message 310-d indicates a second reserved resource 315-b to be used by the third UE 115 for sidelink communications within the shared radio frequency spectrum 320-b. As shown in FIG. 3, the second resource 315-b may be the same as the first resource 315-b reserved by the second UE 115, or may at least partially overlap in time and frequency with the first reserved resource 315-b reserved by the second UE 115. In some cases, the second SCI message 310-d may indicate a second priority (p₂) associated with the second resource 315-b, the sidelink communications scheduled to be performed within the second resource 315-b, the third UE 115, or any combination thereof.

In this example, the second UE 115 and the third UE 115 may be configured to perform different LBT procedures 325-b, 325-c prior to the reserved resources 315-b. Moreover, the first resource 315-b reserved by the second UE 115 (UE2) via the first SCI message 310-c may be within a COT 330-c associated with the second UE 115 (UE2). However, the second resource 315-b reserved by the third UE 115 (UE3) via the second SCI message 310-d may not be positioned within a COT 330-d associated with the third UE 115 (UE3). As such, because the one of the overlapping resources 315-b is out-of-COT, the first UE 115 (UE1) may be configured to identify that no conflict exists, or that LBT procedures 325 performed by the respective UEs 115 are likely to resolve the overlapping resources 315-b prior to any collision. As such, the first UE 115 (UE1) may refrain from transmitting a conflict indication based on determining that no conflict exists.

FIG. 4 illustrates an example of resource configurations 400-a, 400-b that support techniques for channel access-aware conflict determination for unlicensed sidelink bands in accordance with one or more aspects of the present disclosure. In some examples, aspects of the resource configurations 400 may implement, or be implemented by, aspects of the wireless communications system 100, the wireless communications system 200, the resource configurations 300, or any combination thereof.

In particular, the resource configurations 400 illustrate conflict determinations that may be performed at a first UE 115 (UE1) based on channel access type parameters (e.g., based on what types of channel access procedures/LBT procedures will be performed to access the reserved resources).

For example, in some cases, a first UE 115 (UE1) may determine whether a resource conflict exists/occurs if the following conditions are satisfied: (1) a first resource (r₁) reserved by a second UE 115 (UE2) overlaps with a second resource (r₂) reserved by a third UE 115 (UE3), (2) Condition A and/or Condition B related to RSRP measurements of received transmissions described above are satisfied, and (3) the first reserved resource r₁ and the second reserved resource r₂ are associated with the same channel access type.

In such cases, if the first UE 115 determines that a conflict exists based on the channel access type parameters (e.g., whether or not the reserved resources are associated with the same channel access type/LBT type), the first UE 115 may transmit a conflict indication to the UE 115 (e.g., UE2, UE3) with the lower priority transmission.

In other words, if the first channel access type associated with the first reserved resource r₁ and the second channel access type associated with the second reserved resource r₂ are different, the first UE 115-a may be configured to determine that no conflict exists, even if the remaining conditions (e.g., condition 1, condition 2 (Conditions A, B)) are satisfied.

For example, referring to the first resource configuration 400-a, the first UE 115 (UE1) may receive a first SCI message 410-a from a second UE 115 (UE2), where the first SCI message 410-a indicates a first reserved resource 415-a to be used by the second UE 115 for sidelink communications within a shared radio frequency spectrum 420-a (e.g., unlicensed band). In some cases, the first SCI message 410-a may indicate a first priority (p₁) associated with the first reserved resource 415-a, the sidelink communications scheduled to be performed within the first resource 415-a, the second UE 115, or any combination thereof.

Similarly, the first UE 115 may receive a second SCI message 410-b from a third UE 115 (UE3), where the second SCI message 410-b indicates a second reserved resource 415-a to be used by the third UE 115 for sidelink communications within the shared radio frequency spectrum 420-a. As shown in FIG. 4, the second resource 415-a may be the same as the first resource 415-a reserved by the second UE 115, or may at least partially overlap in time and frequency with the first reserved resource 415-a reserved by the second UE 115. In some cases, the second SCI message 410-b may indicate a second priority (p₂) associated with the second resource 415-b, the sidelink communications scheduled to be performed within the second resource 415-b, the third UE 115, or any combination thereof.

In this example, the second UE 115 and the third UE 115 (and/or the first/second reserved resources 415-a) may be configured to perform the same types of LBT procedures 425. For instance, as shown in FIG. 4, the second UE 115 (UE2) may be configured to perform an LBT procedure 425-a including a CAT 2-16 ms LBT procedure, and the third UE 115 (UE3) may be configured to perform an LBT procedure 425-b including a CAT 2-16 ms LBT procedure. As such, because the resources 415-a reserved by the respective UEs 115 are associated with the same type of channel access type (e.g., both CAT 2-16 ms), the first UE 115 (UE1) may be configured to identify a conflict, and transmit a conflict indication to the UE 115 with the lower priority (e.g., transmit conflict indication to UE2 if p₁<p₂).

Comparatively, reference will now be made to the second resource configuration 400-b. As described previously herein, the first UE 115 (UE1) may receive a first SCI message 410-c from a second UE 115 (UE2), where the first SCI message 410-c indicates a first reserved resource 415-b to be used by the second UE 115 for sidelink communications within a shared radio frequency spectrum 420-b (e.g., unlicensed band). In some cases, the first SCI message 410-c may indicate a first priority (p₁) associated with the first reserved resource 415-b, the sidelink communications scheduled to be performed within the first resource 415-b, the second UE 115, or any combination thereof.

Similarly, the first UE 115 may receive a second SCI message 410-d from a third UE 115 (UE3), where the second SCI message 410-d indicates a second reserved resource 415-b to be used by the third UE 115 for sidelink communications within the shared radio frequency spectrum 420-b. As shown in FIG. 3, the second resource 415-b may be the same as the first resource 415-b reserved by the second UE 115, or may at least partially overlap in time and frequency with the first reserved resource 415-b reserved by the second UE 115. In some cases, the second SCI message 410-d may indicate a second priority (p₂) associated with the second resource 415-b, the sidelink communications scheduled to be performed within the second resource 415-b, the third UE 115, or any combination thereof.

In this example, the second UE 115 and the third UE 115 (and/or the first/second reserved resources 415-a) may be configured to perform different types of LBT procedures 425. For instance, as shown in FIG. 4, the second UE 115 (UE2) may be configured to perform an LBT procedure 425-c including a CAT 2 LBT procedure, and the third UE 115 (UE3) may be configured to perform an LBT procedure 425-d including a CAT 4 LBT procedure. As such, because the resources 415-a reserved by the respective UEs 115 are associated with the different channel access types (e.g., CAT 2 and CAT 4), the first UE 115 (UE1) may be configured to identify that no conflict exists, or that LBT procedures 425 performed by the respective UEs 115 are likely to resolve the overlapping resources 415-b prior to any collision. As such, the first UE 115 (UE1) may refrain from transmitting a conflict indication based on determining that no conflict exists.

As shown in the resource configuration 400-b, CAT 2 and CAT 4 LBT procedures may be considered to be different channel access types. Additionally, CAT 2 LBT procedures with different sensing durations may also be considered to be different channel access types. For example, a CAT 2 LBT procedure with a 16 ms sensing duration, and a CAT 2 LBT procedure with a 25 ms sensing duration may be considered to be different channel access types for the purposes of determining conflicts between resources corresponding to the respective LBT procedures.

FIG. 5 illustrates an example of a resource configuration 500 that supports techniques for channel access-aware conflict determination for unlicensed sidelink bands in accordance with one or more aspects of the present disclosure. In some examples, aspects of the resource configuration 500 may implement, or be implemented by, aspects of the wireless communications system 100, the wireless communications system 200, the resource configurations 300, 400, or any combination thereof.

In particular, the resource configuration 500 illustrates conflict determinations that may be performed at a first UE 115 (UE1) based on CPE parameters (e.g., based on CPEs associated with reserved resources).

For example, in some cases, a first UE 115 (UE1) may determine whether a resource conflict exists/occurs if the following conditions are satisfied: (1) a first resource (r₁) reserved by a second UE 115 (UE2) overlaps with a second resource (r₂) reserved by a third UE 115 (UE3), (2) Condition A and/or Condition B related to RSRP measurements of received transmissions described above are satisfied, and (3) the first reserved resource r₁ and the second reserved resource r₂ are associated with the same CPE.

In such cases, if the first UE 115 determines that a conflict exists based on the channel access type parameters (e.g., whether or not the reserved resources are associated with the same CPE), the first UE 115 may transmit a conflict indication to the UE 115 (e.g., UE2, UE3) with the lower priority transmission.

In other words, if the first CPE associated with the first reserved resource r₁ and the second CPE associated with the second reserved resource r₂ are different, the first UE 115-a may be configured to determine that no conflict exists, even if the remaining conditions (e.g., condition 1, condition 2 (Conditions A, B)) are satisfied.

For example, referring generally to the resource configuration 500, the first UE 115 (UE1) may receive a first SCI message 510-a from a second UE 115 (UE2), where the first SCI message 510-a indicates a first reserved resource 515-a to be used by the second UE 115 for sidelink communications within a shared radio frequency spectrum 520 (e.g., unlicensed band). In some cases, the first SCI message 510-a may indicate a first priority (p₁) associated with the first reserved resource 515-a, the sidelink communications scheduled to be performed within the first resource 515-a, the second UE 115, or any combination thereof.

Similarly, the first UE 115 may receive a second SCI message 510-b from a third UE 115 (UE3), where the second SCI message 510-b indicates a second reserved resource 515-a to be used by the third UE 115 for sidelink communications within the shared radio frequency spectrum 520-a. As shown in FIG. 3, the second resource 515-a may be the same as the first resource 515-a reserved by the second UE 115, or may at least partially overlap in time and frequency with the first reserved resource 515-a reserved by the second UE 115. In some cases, the second SCI message 510-b may indicate a second priority (p₂) associated with the second resource 515-b, the sidelink communications scheduled to be performed within the second resource 515-b, the third UE 115, or any combination thereof.

As shown in FIG. 5, the resource(s) 515 reserved by the respective UEs 115 (UE2, UE3) may be associated with a set of symbols 530, where CPEs 540 are used to indicate/determine a starting point of the respective reserved resources 515.

Reference will now be made to the first example 535-a. As shown in the first example 535-a, the first resource 515-a reserved by the second UE 115 (UE2) via the first SCI message 510-a and the second resource 515-b reserved by the third UE 115 (UE3) via the second SCI message 510-b may be associated with the same CPE 540-a. As such, because the resources 515-a, 515-b reserved by the respective UEs 115 are associated with the same CPE 540-a, the first UE 115 (UE1) may be configured to identify a conflict, and transmit a conflict indication to the UE 115 with the lower priority (e.g., transmit conflict indication to UE2 if p₁<p₂).

Comparatively, reference will now be made to the second example 535-b. As shown in the second example 535-b, the first resource 515-c reserved by the second UE 115 (UE2) via the first SCI message 510-a and the second resource 515-d reserved by the third UE 115 (UE3) via the second SCI message 510-b may be associated with different CPEs 540-b, 540-c. As such, because the resources 515-c, 515-d reserved by the respective UEs 115 are associated with the different CPEs 540, the first UE 115 (UE1) may be configured to identify that no conflict exists, or that LBT procedures 525 performed by the respective UEs 115 are likely to resolve the overlapping resources 515 prior to any collision. As such, the first UE 115 (UE1) may refrain from transmitting a conflict indication based on determining that no conflict exists.

FIG. 6 illustrates an example of resource configurations 600 that support techniques for channel access-aware conflict determination for unlicensed sidelink bands in accordance with one or more aspects of the present disclosure. In some examples, aspects of the resource configurations 600 may implement, or be implemented by, aspects of the wireless communications system 100, the wireless communications system 200, the resource configurations 300, 400, 500, or any combination thereof.

In particular, the resource configurations 600 illustrate conflict determinations that may be performed at a first UE 115 (UE1) based on multiple channel access parameters (e.g., based on COT parameters+CPE parameters, based on channel access type parameters+CPE parameters, etc.).

For example, in some cases, a first UE 115 (UE1) may determine whether a resource conflict exists/occurs if the following conditions are satisfied: (1) a first resource (r₁) reserved by a second UE 115 (UE2) overlaps with a second resource (r₂) reserved by a third UE 115 (UE3), (2) Condition A and/or Condition B related to RSRP measurements of received transmissions described above are satisfied, (3) the first reserved resource r₁ is within a COT associated with (or shared to/with) the second UE 115, and the second reserved resource r₂ is within a COT associated with (or shared to/with) the third UE 115, and (4) the first reserved resource r₁ and the second reserved resource r₂ are associated with the same CPE.

In such cases, if the first UE 115 determines that a conflict exists based on the channel access type parameters, the first UE 115 may transmit a conflict indication to the UE 115 (e.g., UE2, UE3) with the lower priority transmission.

For example, referring to the first resource configuration 600-a, the first UE 115 (UE1) may receive a first SCI message 610-a from a second UE 115 (UE2), where the first SCI message 610-a indicates a first reserved resource 615 to be used by the second UE 115 for sidelink communications within a shared radio frequency spectrum 620-a (e.g., unlicensed band). In some cases, the first SCI message 610-a may indicate a first priority (p₁) associated with the first reserved resource 615, the sidelink communications scheduled to be performed within the first resource 615, the second UE 115, or any combination thereof.

Similarly, the first UE 115 may receive a second SCI message 610-b from a third UE 115 (UE3), where the second SCI message 610-b indicates a second reserved resource 615 to be used by the third UE 115 for sidelink communications within the shared radio frequency spectrum 620-a. As shown in FIG. 6, the second resource 615 may be the same as the first resource 615 reserved by the second UE 115, or may at least partially overlap in time and frequency with the first reserved resource 615-a reserved by the second UE 115. In some cases, the second SCI message 610-b may indicate a second priority (p₂) associated with the second resource 615, the sidelink communications scheduled to be performed within the second resource 615, the third UE 115, or any combination thereof.

As shown in FIG. 6, the resource(s) 615 reserved by the respective UEs 115 (UE2, UE3) may be associated with a set of symbols 640, where CPEs 635 are used to indicate/determine a starting point of the respective reserved resources 615. Moreover, as shown in FIG. 6, the first resource 615-a reserved by the second UE 115 (UE2) via the first SCI message 610-a and the second resource 615-b reserved by the third UE 115 (UE3) via the second SCI message 610-b may be associated with the same CPE 635-a.

In this example illustrated in the first resource configuration 600-a, the second UE 115 and the third UE 115 may be configured to perform a same LBT procedure 625-a prior to the reserved resources 615. Moreover, the reserved resources 615 may be within a COT 630 associated with each of the respective UEs 115. In particular, the first resource 615-a reserved by the first SCI message 610-a is within a COT 630-a associated with (or shared to/with) the second UE 115 (UE2), and the second resource 615-b reserved by the second SCI message 610-b is within a COT 630-b associated with (or shared to/with) the third UE 115 (UE3). Further, the reserved resources 615-a, 615-b are associated with the same CPE 635-a. As such, because the resources 615 reserved by the respective UEs 115 are positioned within COTs 630 associated with the respective UEs 115, and because the resources 615 are associated with the same CPE 635-a, the first UE 115 (UE1) may be configured to identify a conflict, and transmit a conflict indication to the UE 115 with the lower priority (e.g., transmit conflict indication to UE2 if p₁<p₂).

In additional or alternative cases, the first UE 115 (UE1) may determine whether a resource conflict exists/occurs if the following conditions are satisfied: (1) a first resource (r₁) reserved by a second UE 115 (UE2) overlaps with a second resource (r₂) reserved by a third UE 115 (UE3), (2) Condition A and/or Condition B related to RSRP measurements of received transmissions described above are satisfied, (3) the first reserved resource r₁ and the second reserved resource r₂ are associated with a same channel access type, and (4) the first reserved resource r₁ and the second reserved resource r₂ are associated with the same CPE.

In such cases, if the first UE 115 determines that a conflict exists based on the channel access type parameters, the first UE 115 may transmit a conflict indication to the UE 115 (e.g., UE2, UE3) with the lower priority transmission.

For example, referring to the second resource configuration 600-b, the first UE 115 (UE1) may receive a first SCI message 610-c from a second UE 115 (UE2), where the first SCI message 610-c indicates a first reserved resource 615 to be used by the second UE 115 for sidelink communications within a shared radio frequency spectrum 620-b (e.g., unlicensed band). In some cases, the first SCI message 610-c may indicate a first priority (p₁) associated with the first reserved resource 615, the sidelink communications scheduled to be performed within the first resource 615, the second UE 115, or any combination thereof.

Similarly, the first UE 115 may receive a second SCI message 610-d from a third UE 115 (UE3), where the second SCI message 610-d indicates a second reserved resource 615 to be used by the third UE 115 for sidelink communications within the shared radio frequency spectrum 620-b. As shown in FIG. 6, the second resource 615 may be the same as the first resource 615 reserved by the second UE 115, or may at least partially overlap in time and frequency with the first reserved resource 615 reserved by the second UE 115. In some cases, the second SCI message 610-d may indicate a second priority (p₂) associated with the second resource 615, the sidelink communications scheduled to be performed within the second resource 615, the third UE 115, or any combination thereof.

As shown in FIG. 6, the resource(s) 615 reserved by the respective UEs 115 (UE2, UE3) may be associated with the set of symbols 640, where CPEs 635 are used to indicate/determine a starting point of the respective reserved resources 615. Moreover, as shown in FIG. 6, the first resource 615-a reserved by the second UE 115 (UE2) via the first SCI message 610-a and the second resource 615-b reserved by the third UE 115 (UE3) via the second SCI message 610-b may be associated with the same CPE 635-a.

In this example illustrated in the second resource configuration 600-b, the first resource reserved by the second UE 115 may be associated with a first LBT procedure 625-b of a first type (e.g., CAT 2), and the second resource reserved by the third UE 115 may be associated with a second LBT procedure 625-c of a second type (e.g., CAT 4). In other words, the resources may be associated with different channel access types (e.g., channel access type parameters). Accordingly, because the resources 615 reserved by the respective UEs 115 are associated with different channel access types (e.g., CAT 2 and CAT 3), the first UE 115 (UE1) may be configured to determine that there is no conflict between the resources 615 even though the resources 615 are associated with the same CPE 635-a. As such, the first UE 115 (UE1) may refrain from transmitting a conflict indication based on determining that no conflict exists.

FIG. 7 illustrates an example of a resource configuration 700 that supports techniques for channel access-aware conflict determination for unlicensed sidelink bands in accordance with one or more aspects of the present disclosure. In some examples, aspects of the resource configuration 700 may implement, or be implemented by, aspects of the wireless communications system 100, the wireless communications system 200, the resource configurations 300, 400, 500, 600, or any combination thereof.

In particular, the resource configuration 700 illustrate conflict determinations that may be performed at a first UE 115 (UE1) based on COT parameters and a quantity of conflicting resources.

As described previously herein in the context of two overlapping resources (as shown in FIGS. 3-6), the first UE 115 may determine that no conflict exists if at least one of the first reserved resource r₁ and the second reserved resource r₂ is not within a COT of the corresponding UE 115 or not within a shared COT to the corresponding UE 115. Moreover, in the context of two overlapping resources, the first UE 115 may determine that no conflict exists if the first reserved resource r₁ and the second reserved resource r₂ have different channel access types and/or different CPEs.

However, in some cases, as shown in FIG. 7, there may be more than two overlapping resources reserved by more than two UEs 115 (e.g., UE2, UE3, and UE4). As the number/quantity of overlapping resources increases, the probability that the overlapping resources will result in a collision/conflict increases (e.g., less likely that LBT procedures will resolve the overlapping resources). As such, in cases with more than two overlapping resources, the first UE 115 (UE1) may be configured to indicate a resource conflict based on the number of overlapping resources regardless of whether the potentially conflicting resources are within a COT or outside a COT, whether the overlapping resources have the same channel access types and/or CPEs, and the like.

For example, referring to the resource configuration 700, the first UE 115 (UE1) may receive a first SCI message 710-a from a second UE 115 (UE2), where the first SCI message 710-a indicates a first reserved resource 715 to be used by the second UE 115 for sidelink communications within a shared radio frequency spectrum 720 (e.g., unlicensed band). In some cases, the first SCI message 710-a may indicate a first priority (p₁) associated with the first reserved resource 715, the sidelink communications scheduled to be performed within the first resource 715, the second UE 115, or any combination thereof.

Similarly, the first UE 115 may receive a second SCI message 710-b and a third SCI message 710-c from a third UE 115 (UE3) and a fourth UE 115 (UE4), respectively. The SCI messages 710-b, 710-c may indicate a second reserved resource 715 and a third reserved resource 715, respectively, to be used by the third UE 115 (UE3) and the fourth UE 115 (UE4), respectively, for sidelink communications within the shared radio frequency spectrum 720. As shown in FIG. 4, the second resource 715, the third resource 715, or both, may be the same as the first resource 715 reserved by the second UE 115, or may at least partially overlap in time and frequency with the first reserved resource 715 reserved by the second UE 115. In some cases, the second SCI message 710-b may indicate a second priority (p₂) associated with the second resource 715, the sidelink communications scheduled to be performed within the second resource 715, the third UE 115 (UE3), or any combination thereof. Similarly, the third SCI message 710-c may indicate a third priority (p₃) associated with the third resource 715, the sidelink communications scheduled to be performed within the third resource 715, the fourth UE 115 (UE4), or any combination thereof.

In this example, the second UE 115 (UE2), the third UE 115 (UE3), and the fourth UE 115 (UE4) may be configured to perform the LBT procedures 725-a, 725-b, and 725-c, respectively. Moreover, the resources reserved by the second UE 115 (UE2), the third UE 115 (UE3), and the fourth UE 115 (UE4) may be associated with COTs 730-a, 730-b, and 730-c, respectively.

In this example, the first resource r₁ reserved by the first SCI message 710-a is within the COT 730-a, and the second resource r₂ reserved by the second SCI message 710-b is outside of the COT 730-b. As such, according to the rules/conditions described above, the first UE 115 may not determine a conflict between the overlapping resources (due to the second resource being out-of-COT). Similarly, the first resource r₁ reserved by the first SCI message 710-a is within the COT 730-a, and the third resource r₃ reserved by the third SCI message 710-c is outside of the COT 730-c. As such, according to the rules/conditions described above, the first UE 115 may not determine a conflict between the first and third overlapping resources (due to the third resource r₃ being out-of-COT). Moreover, both the second resource r₂ and the third resource r₂ reserved by the second SCI message 710-b and the third SCI message 710-c, respectively, are outside of the respective COTs 730-b, 730-c. As such, the first UE 115 may determine that no conflict exists between the second and third resources.

In this example, the first UE 115 may determine that there is no conflict between any two pairs of overlapping resources (e.g., no conflict between, r₁ and r₂, no conflict between r₁ and r₃, no conflict between r₂ and r₃). However, due to the fact that there are three overlapping resources (r₁, r₂, r₃), the first UE 115 may nonetheless determine that there is a conflict due to the quantity of the overlapping resources exceeding some threshold (as the probability that the overlapping resources will result in a collision increases with increasing quantities of overlapping resource).

In this regard, in some implementations, the first UE 115 (UE1) may determine whether a resource conflict exists/occurs if the following conditions are satisfied: (1) a first resource (r₁) reserved by a second UE 115 (UE2) overlaps with more than one additional reserved resource (r₂, r₃, . . . rₙ) reserved by additional UEs 115 (e.g., UE3, UE4, . . . , UEn), (2) at least one of Condition C or D below are satisfied, and (3) the quantity of overlapping resources that satisfy the conditions above are larger than some threshold where the threshold may be fixed or configured.

In some aspects, Condition C mentioned above may be satisfied if the RSRP measurement of the transmission received by the first UE 115 (UE1) is above a threshold. For example, if the first UE 115 (UE1) is an intended receiver for a PSSCH message in a reserved resource of the second UE 115 (UE2), Condition C may be satisfied if the RSRP of signals received from each of the additional UEs 115 (UE3, UE4) is above a threshold (Th(pⱼ, pᵢ)), where pⱼ is the priority of the second UE 115, and pᵢ is the priority of i-th UE 115 among the multiple UEs 115 which reserved overlapping resources. By way of another example, if the first UE 115 (UE1) is an intended receiver for a PSSCH message in a reserved resource of a third UE 115 (UE3) of multiple UEs 115 which reserved overlapping resources, Condition C may be satisfied if the RSRP of signals received from each of the multiple UEs 115 (e.g., UE2, UE4) excluding the third UE 115 (UE3) is above a threshold Th(pⱼ, pᵢ), where pⱼ is the priority of the third UE 115 (UE3), pᵢ is the priority of i-th UE 115 among the second UE 115 and the multiple UEs 115 which reserved overlapping resources (excluding the third UE 115). In this example, the threshold Th(pⱼ, pᵢ)) may be configured by RRC.

In some aspects, Condition D mentioned above may be satisfied when the difference in RSRP measurements between the conflicting transmissions is above a threshold. For example, if the first UE 115 (UE1) is an intended receiver for a PSSCH message in a resource reserved by the second UE 115 (UE2), Condition D may be satisfied if, for each of the multiple UEs 115 which reserved overlapping resources, RSRPⱼ>RSRPᵢ+Delta_Thᵢ, where RSRPᵢ and RSRPⱼ are the RSRP measurements performed by the first UE 115 (UE1) on signals received from the second UE 115 (UE2) and j-th UE 115 of the multiple UEs 115 which reserved overlapping resources. By way of another example, if the first UE 115 (UE1) is an intended receiver for a PSSCH message in a reserved resource of a third UE 115 (UE3) of multiple UEs 115 which reserved overlapping resources, the first UE 115 (UE1) may determine a resource conflict (e.g., Condition D is satisfied) if RSRPⱼ>RSRPᵢ+Delta_Thᵢ, where RSRPᵢ and RSRPⱼ are the RSRP measurements performed by the first UE 115 on signals received from the second UE 115 (UE2) and j-th UE 115 of the multiple UEs 115 which reserved overlapping resources (excluding the third UE 115). In this example, Delta_Thᵢ may be configured by RRC, which can be same for different priority or can be priority-specific.

In this example, assume the threshold of overlapping resources is 2. Upon receiving the second SCI message 710-b, the first UE 115 may determine that there are only two overlapping resources 715 (e.g., first and second resources 715 reserved by the first SCI message 710-a and the second SCI message 710-b, respectively). As such, the first UE 115 may determine that the quantity of overlapping resources does not exceed the threshold of 2, and may therefore determine that no conflict exists. However, after receiving the third SCI message 710-c reserving a third resource 715, the first UE 115 may determine that there are three overlapping resources 715 (e.g., first and second resources 715 reserved by the first SCI message 710-a, the second SCI message 710-b, and the third SCI message 710-c, respectively). As such, the first UE 115 may determine that the quantity of overlapping resources 715 is greater than the threshold, and may therefore determine that a conflict exists, and may transmit conflict indications to the UEs 115 with the lowest priorities (e.g., transmit conflict indication to UE2 and UE3 if p₁<p₂<p₃).

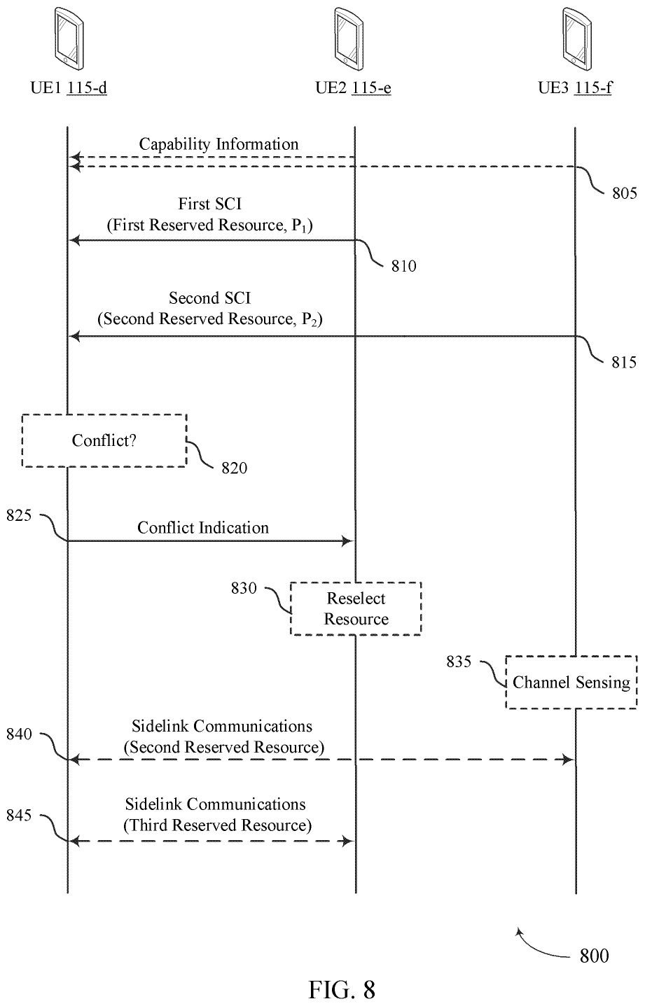

FIG. 8 illustrates an example of a process flow 800 that supports techniques for channel access-aware conflict determination for unlicensed sidelink bands in accordance with one or more aspects of the present disclosure. In some examples, aspects of the process flow 800 may implement, or be implemented by, aspects of the wireless communications system 100, the wireless communications system 200, the resource configurations 300, 400, 500, 600, 700, or any combination thereof. For example, process flow 800 illustrates signaling and configurations that enable a first UE 115-d to identify resource conflicts between resources reserved by other UEs 115 based on one or more channel access parameters, as described with reference to FIGS. 1-8.

The process flow 800 includes a first UE 115-d, a second UE 115-e, and a third UE 115-f, which may be examples of wireless devices as described herein. For example, the first UE 115-d, the second UE 115-e, and the third UE 115-f illustrated in FIG. 8 may be examples of the first UE 115-a, the second UE 115-b, and the third UE 115-c, respectively, as illustrated in FIG. 2.

In some examples, the operations illustrated in process flow 800 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 805, the first UE 115-d may receive, from the second UE 115-e, the third UE 115-f, or both, capability information/signaling which indicates whether the second UE 115-e and/or third UE 115-f are capable of receiving conflict indications. In some cases, the capability information may be communicated via SCI messages. In other words, the UEs 115-e, 115-f may broadcast or otherwise indicate whether the UEs 115-e, 115-f are capable of receiving inter-UE coordination messages (e.g., PSFCH messages, SCI messages) indicating resource conflicts.

At 810, the first UE 115-d may receive a first SCI message (and/or another sidelink control message) from the second UE 115-e, where the first SCI message indicates a first reserved resource to be used by the second UE 115-e for sidelink communications within a shared radio frequency band (e.g., unlicensed band). In some cases, the first SCI message may indicate a first priority (p₁) associated with the reserved first resource, the sidelink communications scheduled to be performed within the first resource, the second UE 115-e, or any combination thereof.

At 815, the first UE 115-d may receive a second SCI message (and/or another sidelink control message) from the third UE 115-f, where the second SCI message indicates a second reserved resource to be used by the third UE 115-f for sidelink communications within the shared radio frequency band. In this example, the second resource reserved by the third UE 115-f may at least partially overlap in time and frequency with the first resource reserved by the second UE 115-e. In some cases, the second SCI message may indicate a second priority (p₂) associated with the reserved second resource, the sidelink communications scheduled to be performed within the second resource, the third UE 115-f, or any combination thereof.

At 815, the first UE 115-d may determine whether or not a conflict exists between the first resource reserved by the second UE 115-e and the second resource reserved by the third UE 115-f. In particular, the first UE 115-d may determine whether or not a conflict exists based on whether the overlapping resources are likely to result in a collision or be resolved via LBT procedures at the respective UEs 115-e, 115-f. In this regard, the first UE 115-d may determine whether or not a conflict exists based on receiving the first SCI message at 810, receiving the second SCI message at 815, or both.

In some aspects, the first UE 115-d may determine whether a conflict exists based on the first resource and the second resource at least partially overlapping with one another in time and frequency. Additionally, the first UE 115-d may determine whether a conflict exists based on a signal strength associated with signals (e.g., SCI messages) received from the second UE 115-e, the third UE 115-f, or both.

Further, the first UE 115-d may determine whether a conflict exists based on one or more additional channel access parameters associated with communications at/with the second UE 115-e, the third UE 115-f, or both. Channel access parameters used for performing conflict determination may include, but are not limited to, COT parameters (e.g., whether the reserved resources fall within a COT of the respective UEs 115-e, 115-f), channel access type parameters (e.g., what types of LBT procedures will be performed by the UEs 115-e, 115-f), CPE parameters (e.g., when transmissions within the conflicting reserved resources are scheduled to begin), and the like. As described previously herein, channel access parameters may be used by the first UE 115-d to determine a relative likelihood or probability that overlapping resources are likely to result in a collision (e.g., relative probability that LBT procedures will resolve the potential conflict prior to collision).

For example, in some cases, as shown in FIG. 3, the first UE 115-d may determine whether or not a conflict exists based on a COT parameter associated with the second UE 115-e, the third UE 115-f, or both. In this example, the first UE 115-d may determine that a conflict exists if the first resource reserved by the second UE 115-e is in a COT associated with (or shared to/with) the second UE 115-e, and if the second resource reserved by the third UE 115-f is in a COT associated with (or shared to/with) the third UE 115-f. In other words, if at least one of the first resource or the second resource is not within a COT of the respective corresponding UE 115-e, 115-f, the first UE 115-d may be configured to determine that no conflict exists (or that LBT procedures performed at the respective UEs 115-e, 115-f are likely to resolve the potential conflict prior to collision).

By way of another example, in some cases, as shown in FIG. 4, the first UE 115-d may determine whether or not a conflict exists based on a channel access type parameter associated with the second UE 115-e, the third UE 115-f, or both. In this example, the first UE 115-d may determine that a conflict exists if first resource reserved by the second UE 115-e and the second resource reserved by the third UE 115-f are associated with a same channel access type (e.g., both CAT 2 16 ms, both CAT 2 25 ms, both CAT 4, etc.). In other words, if the first channel access type associated with the first resource reserved by the second UE 115-e and the second channel access type associated with the second resource reserved by the third UE 115-f are different, the first UE 115-d may be configured to determine that no conflict exists (or that LBT procedures performed at the respective UEs 115-e, 115-f are likely to resolve the potential conflict prior to collision).

By way of another example, in some cases, as shown in FIG. 5, the first UE 115-d may determine whether or not a conflict exists based on a CPE parameter associated with transmissions to be performed by the second UE 115-e, the third UE 115-f, or both. In this example, the first UE 115-d may determine that a conflict exists if first resource reserved by the second UE 115-e and the second resource reserved by the third UE 115-f are associated with a same CPE. In other words, if a first CPE associated with the first resource and a second CPE associated with the second resource are different (e.g., transmissions within the resources are scheduled to begin at different times), the first UE 115-d may be configured to determine that no conflict exists (or that LBT procedures performed at the respective UEs 115-e, 115-f are likely to resolve the potential conflict prior to collision).

As noted previously herein, in some cases, the first UE 115-d may be configured to evaluate whether or not a conflict exists based on one or more channel access parameters (as shown in FIG. 6). Moreover, in some cases, the first UE 115-d may be configured to evaluate whether or not a conflict exists based on how many overlapping resources there are (e.g., how many UEs 115 have reserved overlapping resources) (as shown in FIG. 7).

In cases where the first UE 115-d determines that there is no conflict (or that the overlapping resources are unlikely to result in a collision), the first UE 115-d may refrain from transmitting a conflict indication. Conversely, in cases where the first UE 115-d determines that there is a conflict (e.g., that overlapping resources are likely to result in a collision), the process flow 800 may proceed to step 825.

At 825, the first UE 115-d may transmit an indication of the identified conflict to the second UE 115-e, the third UE 115-f, or both. The indication of the conflict may be transmitted via an SCI message, a PSFCH message, and the like.

For example, in cases where the first resource/transmission reserved or scheduled by the second UE 115-e is associated with a lower priority as compared to the second resource/transmission reserved or scheduled by the third UE 115-f (e.g., p₂>p₁) the first UE 115-d may transmit an indication of the conflict to the second UE 115-e based on the second UE 115-e being associated with the lower priority.

The first UE 115-d may transmit the indication of the conflict based on receiving the capability information at 805, receiving the first SCI message at 810, receiving the second SCI message at 815, determining the existence of the conflict at 820, or any combination thereof. For instance, the first UE 115-d may transmit the indication of the conflict based on first reserved resource overlapping with the second reserved resource in time and frequency, a signal strength for a signal received from the second UE 115-e, the third UE 115-f, or both, and at least one channel access parameter for communications with the second UE 115-e, the third UE 115-f, or both.

At 830, the second UE 115-e may select a new resource (e.g., third resource) for performing the sidelink communications. In particular, the second UE 115-e may select a new resource based on receiving the indication of the conflict from the first UE 115-d at 825. In some cases, the second UE 115-e may transmit another SCI message reserving the newly selected resource to enable other UEs 115 to perform conflict determination for the new resource, as described herein.

At 835, the third UE 115-f may perform channel sensing as part of an LBT procedure. In other words, the third UE 115-f may perform channel sensing during a time interval prior to the second resource reserved via the second SCI message at 815 in order to gain access to the shared radio frequency spectrum and to perform a sidelink communication within the second reserved resource.

At 840, third UE 115-f may perform a sidelink communication within the second resource reserved via the second SCI message at 815. For example, as shown in FIG. 8, in cases where the first UE 115-d is the intended receiver of a sidelink message within the second reserved resource, the third UE 115-f may transmit the sidelink message to the first UE 115-d within the second reserved resource. Moreover, the third UE 115-f may perform (e.g., transmit) the sidelink message at 840 based on performing (e.g., clearing) the LBT procedure at 835.

At 845, second UE 115-e may perform a sidelink communication within the third resource selected at 830. For example, as shown in FIG. 8, in cases where the first UE 115-d is the intended receiver of a sidelink message within the third reserved resource, the second UE 115-e may transmit the sidelink message to the first UE 115-d within the third reserved resource. Moreover, the second UE 115-e may perform (e.g., transmit) the sidelink message at 845 based on performing (e.g., clearing) an LBT procedure prior to the third reserved resource. In this regard, the second UE 115-e may perform the sidelink communications based on receiving the conflict indication at 825, reselecting the third resource at 830, performing an LBT procedure, or any combination thereof.

Techniques described herein may enable UEs 115 to identify and resolve potential conflicts within a shared radio frequency band, such as an unlicensed sidelink band. In particular, techniques described herein may utilize channel access parameters associated with sidelink communications between devices in order to determine a relative likelihood that LBT procedures will resolve potential conflicts. In this regard, techniques described herein may enable UEs1 115 to determine whether conflicts exist, and whether the UEs 115 are expected to transmit conflict indications to help avoid the conflict. As such, aspects of the present disclosure may reduce interference and noise within shared radio frequency bands, and may lead to more efficient resource utilization within the shared radio frequency bands.

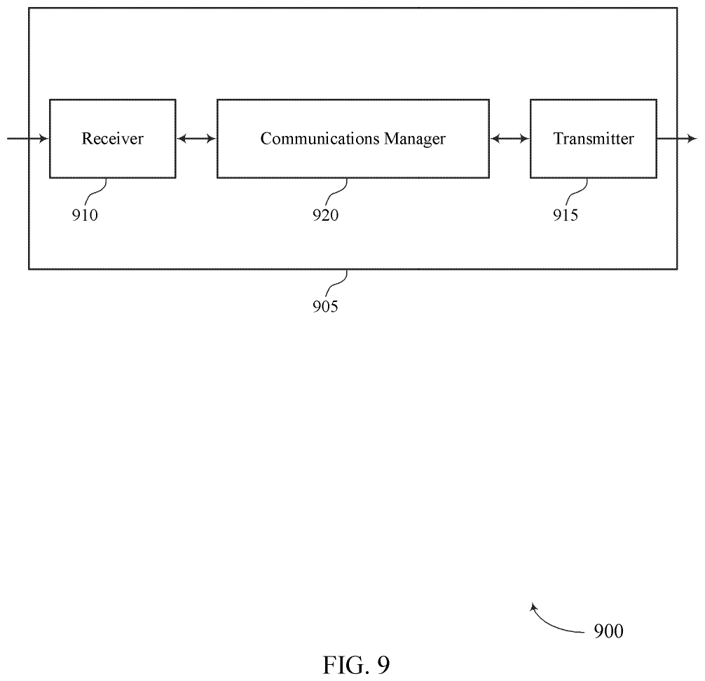

FIG. 9 shows a block diagram 900 of a device 905 that supports techniques for channel access-aware conflict determination for unlicensed sidelink bands in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for channel access-aware conflict determination for unlicensed sidelink bands). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for channel access-aware conflict determination for unlicensed sidelink bands). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of techniques for channel access-aware conflict determination for unlicensed sidelink bands as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a first UE in accordance with examples as disclosed herein. For example, the communications manager 920 may be configured as or otherwise support a means for receiving, from a second UE, a first sidelink control message indicating a first reserved resource to be used by the second UE for sidelink communications in a shared radio frequency spectrum band. The communications manager 920 may be configured as or otherwise support a means for receiving, from a third UE, a second sidelink control message indicating a second reserved resource to be used by the third UE for sidelink communications in the shared radio frequency spectrum band. The communications manager 920 may be configured as or otherwise support a means for transmitting an indication of a conflict between the first reserved resource indicated by the first sidelink control message and the second reserved resource indicated by the second sidelink control message based on the first reserved resource overlapping with the second reserved resource in time and frequency, a signal strength for a signal received from the second UE, the third UE, or both, and at least one channel access parameter for communications with the second UE, the third UE, or both.

By including or configuring the communications manager 920 in accordance with examples as described herein, the device 905 (e.g., a processor controlling or otherwise coupled with the receiver 910, the transmitter 915, the communications manager 920, or a combination thereof) may support techniques that enable UEs 115 to identify and resolve potential conflicts within a shared radio frequency band, such as an unlicensed sidelink band. In particular, techniques described herein may utilize channel access parameters associated with sidelink communications between devices in order to determine a relative likelihood that LBT procedures will resolve potential conflicts. In this regard, techniques described herein may enable UEs1 115 to determine whether conflicts exist, and whether the UEs 115 are expected to transmit conflict indications to help avoid the conflict. As such, aspects of the present disclosure may reduce interference and noise within shared radio frequency bands, and may lead to more efficient resource utilization within the shared radio frequency bands.

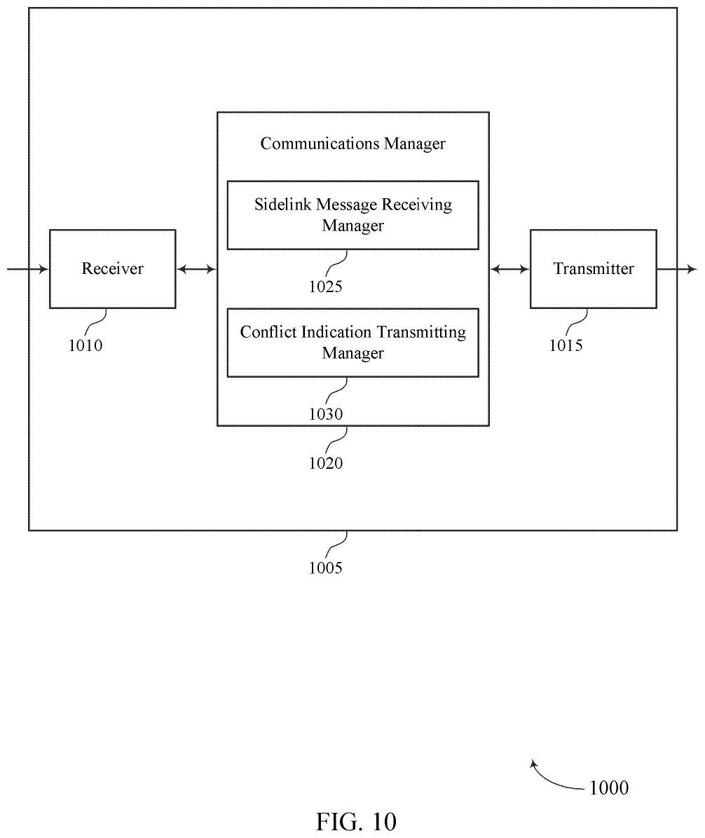

FIG. 10 shows a block diagram 1000 of a device 1005 that supports techniques for channel access-aware conflict determination for unlicensed sidelink bands in accordance with one or more aspects of the present disclosure. The device 1005 may be an example of aspects of a device 905 or a UE 115 as described herein.

The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for channel access-aware conflict determination for unlicensed sidelink bands). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for channel access-aware conflict determination for unlicensed sidelink bands). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of techniques for channel access-aware conflict determination for unlicensed sidelink bands as described herein. For example, the communications manager 1020 may include a sidelink message receiving manager 1025 a conflict indication transmitting manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a first UE in accordance with examples as disclosed herein. The sidelink message receiving manager 1025 may be configured as or otherwise support a means for receiving, from a second UE, a first sidelink control message indicating a first reserved resource to be used by the second UE for sidelink communications in a shared radio frequency spectrum band. The sidelink message receiving manager 1025 may be configured as or otherwise support a means for receiving, from a third UE, a second sidelink control message indicating a second reserved resource to be used by the third UE for sidelink communications in the shared radio frequency spectrum band. The conflict indication transmitting manager 1030 may be configured as or otherwise support a means for transmitting an indication of a conflict between the first reserved resource indicated by the first sidelink control message and the second reserved resource indicated by the second sidelink control message based on the first reserved resource overlapping with the second reserved resource in time and frequency, a signal strength for a signal received from the second UE, the third UE, or both, and at least one channel access parameter for communications with the second UE, the third UE, or both.

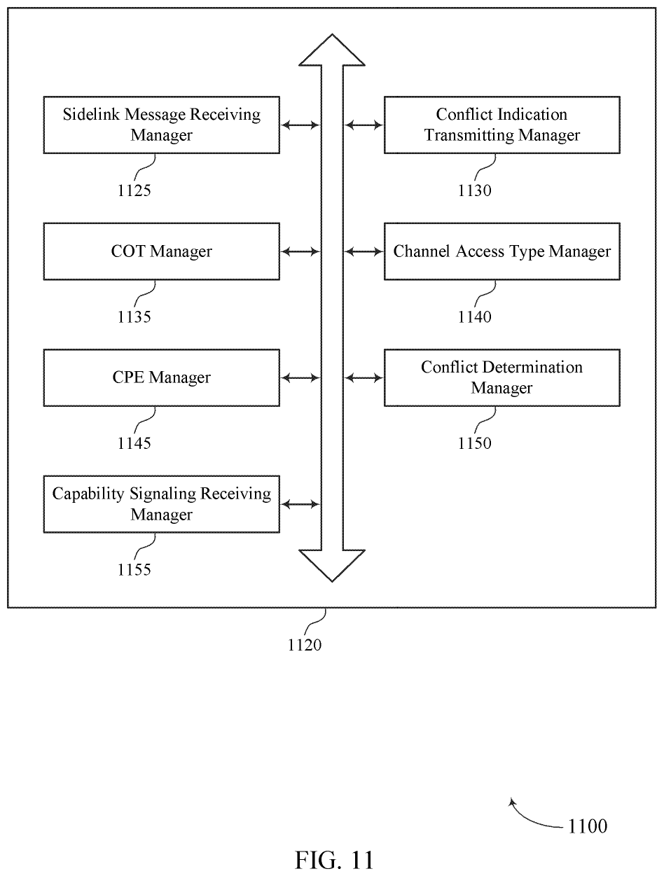

FIG. 11 shows a block diagram 1100 of a communications manager 1120 that supports techniques for channel access-aware conflict determination for unlicensed sidelink bands in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for channel access-aware conflict determination for unlicensed sidelink bands as described herein. For example, the communications manager 1120 may include a sidelink message receiving manager 1125, a conflict indication transmitting manager 1130, a COT manager 1135, a channel access type manager 1140, a CPE manager 1145, a conflict determination manager 1150, a capability signaling receiving manager 1155, or any combination thereof. Each of these components may communicate, directly or indirectly, with one another (e.g., via one or more buses).

The communications manager 1120 may support wireless communication at a first UE in accordance with examples as disclosed herein. The sidelink message receiving manager 1125 may be configured as or otherwise support a means for receiving, from a second UE, a first sidelink control message indicating a first reserved resource to be used by the second UE for sidelink communications in a shared radio frequency spectrum band. In some examples, the sidelink message receiving manager 1125 may be configured as or otherwise support a means for receiving, from a third UE, a second sidelink control message indicating a second reserved resource to be used by the third UE for sidelink communications in the shared radio frequency spectrum band. The conflict indication transmitting manager 1130 may be configured as or otherwise support a means for transmitting an indication of a conflict between the first reserved resource indicated by the first sidelink control message and the second reserved resource indicated by the second sidelink control message based on the first reserved resource overlapping with the second reserved resource in time and frequency, a signal strength for a signal received from the second UE, the third UE, or both, and at least one channel access parameter for communications with the second UE, the third UE, or both.

In some examples, the COT manager 1135 may be configured as or otherwise support a means for determining that the conflict exists based on the first reserved resource being within a first COT associated with the second UE, shared with the second UE, or both, and based on the second reserved resource being within a second COT associated with the third UE, shared with the third UE, or both, where the at least one channel access parameter includes a COT parameter.

In some examples, the channel access type manager 1140 may be configured as or otherwise support a means for determining that the conflict exists based on a first channel access type associated with the first reserved resource being a same channel access type as a second channel access type associated with the second reserved resource, where the at least one channel access parameter includes a channel access type parameter.

In some examples, the CPE manager 1145 may be configured as or otherwise support a means for determining that the conflict exists based on a first CPE associated with the first reserved resource being a same CPE as a second CPE associated with the second reserved resource, where the at least one channel access parameter includes a CPE parameter.

In some examples, the COT manager 1135 may be configured as or otherwise support a means for determining that the conflict exists based on the first reserved resource being within a first COT associated with the second UE, shared with the second UE, or both, and based on the second reserved resource being within a second COT associated with the third UE, shared with the third UE, or both, and based on a first CPE associated with the first reserved resource being a same CPE as a second CPE associated with the second reserved resource, where the at least one channel access parameter includes a COT parameter and a CPE parameter.

In some examples, the channel access type manager 1140 may be configured as or otherwise support a means for determining that the conflict exists based on a first channel access type associated with the first reserved resource being a same channel access type as a second channel access type associated with the second reserved resource, and based on a first CPE associated with the first reserved resource being a same CPE as a second CPE associated with the second reserved resource, where the at least one channel access parameter includes a channel access type parameter and a CPE parameter.

In some examples, the conflict determination manager 1150 may be configured as or otherwise support a means for determining that the conflict exists based on a quantity of conflicting resources satisfying a quantity threshold, where the quantity of conflicting resources is identified based on, for each respective resource of a set of multiple resources for a set of multiple UEs coordinated by the first UE, whether a signal strength for a signal received on the respective resource satisfies a signal strength threshold.

In some examples, the conflict determination manager 1150 may be configured as or otherwise support a means for determining that the conflict between the first reserved resource and the second reserved resource exists based on a first signal strength associated with a first signal received from the second UE satisfying a signal strength threshold.

In some examples, the conflict determination manager 1150 may be configured as or otherwise support a means for determining that the conflict between the first reserved resource and the second reserved resource exists based on a difference between the first signal strength associated with the first signal received from the second UE and a second signal strength associated with a second signal received from the third UE satisfying a signal strength difference threshold.

In some examples, the conflict indication transmitting manager 1130 may be configured as or otherwise support a means for transmitting the indication of the conflict to the second UE based on a first transmission of the second UE indicated by the first sidelink control message having a lower priority than a second transmission of the third UE indicated by the second sidelink control message.

In some examples, the sidelink message receiving manager 1125 may be configured as or otherwise support a means for receiving, from the second UE responsive to the indication of the conflict, a third sidelink control message identifying a third reserved resource different from the first reserved resource to be used by the second UE for sidelink communications.

In some examples, the capability signaling receiving manager 1155 may be configured as or otherwise support a means for receiving, from the second UE, capability signaling via an SCI message indicating that the second UE is capable of receiving the indication of the conflict. In some examples, the conflict indication transmitting manager 1130 may be configured as or otherwise support a means for transmitting the indication of the conflict to the second UE via a physical sidelink feedback channel based on receiving the capability signaling.

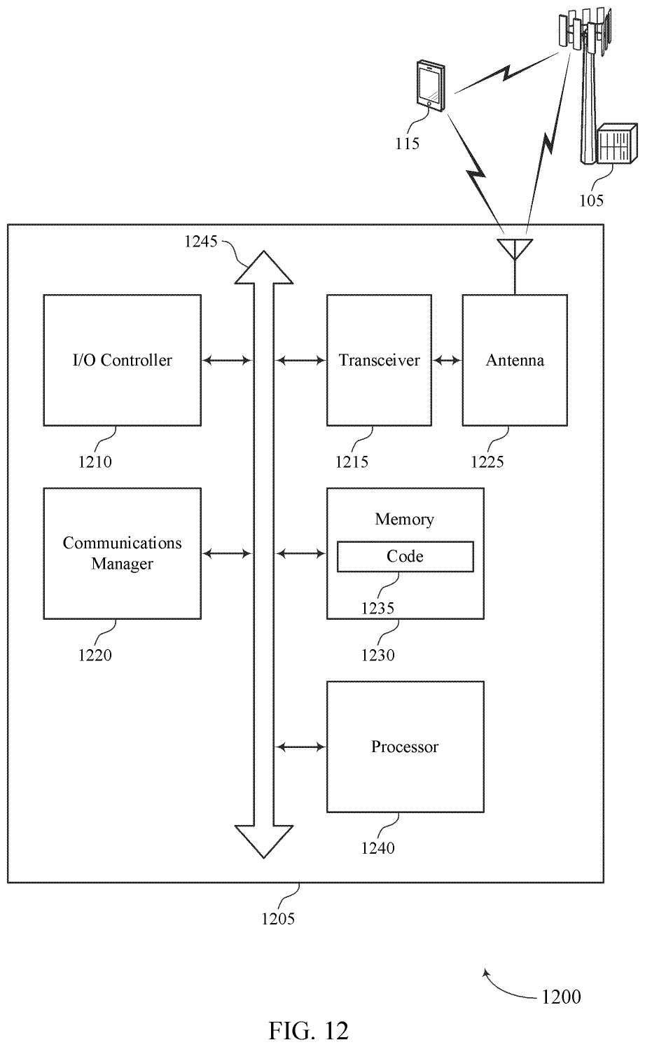

FIG. 12 shows a diagram of a system 1200 including a device 1205 that supports techniques for channel access-aware conflict determination for unlicensed sidelink bands in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for channel access-aware conflict determination for unlicensed sidelink bands). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a first UE in accordance with examples as disclosed herein. For example, the communications manager 1220 may be configured as or otherwise support a means for receiving, from a second UE, a first sidelink control message indicating a first reserved resource to be used by the second UE for sidelink communications in a shared radio frequency spectrum band. The communications manager 1220 may be configured as or otherwise support a means for receiving, from a third UE, a second sidelink control message indicating a second reserved resource to be used by the third UE for sidelink communications in the shared radio frequency spectrum band. The communications manager 1220 may be configured as or otherwise support a means for transmitting an indication of a conflict between the first reserved resource indicated by the first sidelink control message and the second reserved resource indicated by the second sidelink control message based on the first reserved resource overlapping with the second reserved resource in time and frequency, a signal strength for a signal received from the second UE, the third UE, or both, and at least one channel access parameter for communications with the second UE, the third UE, or both.

By including or configuring the communications manager 1220 in accordance with examples as described herein, the device 1205 may support techniques that enable UEs 115 to identify and resolve potential conflicts within a shared radio frequency band, such as an unlicensed sidelink band. In particular, techniques described herein may utilize channel access parameters associated with sidelink communications between devices in order to determine a relative likelihood that LBT procedures will resolve potential conflicts. In this regard, techniques described herein may enable UEs1 115 to determine whether conflicts exist, and whether the UEs 115 are expected to transmit conflict indications to help avoid the conflict. As such, aspects of the present disclosure may reduce interference and noise within shared radio frequency bands, and may lead to more efficient resource utilization within the shared radio frequency bands.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for channel access-aware conflict determination for unlicensed sidelink bands as described herein, or the processor 1240 and the memory 1230 may be otherwise configured to perform or support such operations.

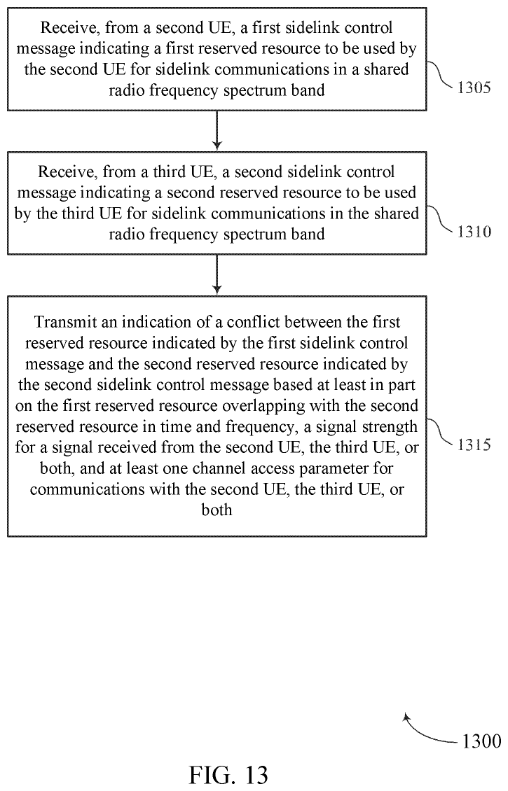

FIG. 13 shows a flowchart illustrating a method 1300 that supports techniques for channel access-aware conflict determination for unlicensed sidelink bands in accordance with one or more aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1305, the method may include receiving, from a second UE, a first sidelink control message indicating a first reserved resource to be used by the second UE for sidelink communications in a shared radio frequency spectrum band. The operations of 1305 may be performed in accordance with examples as disclosed herein. In some examples, aspects of the operations of 1305 may be performed by a sidelink message receiving manager 1125 as described with reference to FIG. 11.

At 1310, the method may include receiving, from a third UE, a second sidelink control message indicating a second reserved resource to be used by the third UE for sidelink communications in the shared radio frequency spectrum band. The operations of 1310 may be performed in accordance with examples as disclosed herein. In some examples, aspects of the operations of 1310 may be performed by a sidelink message receiving manager 1125 as described with reference to FIG. 11.

At 1315, the method may include transmitting an indication of a conflict between the first reserved resource indicated by the first sidelink control message and the second reserved resource indicated by the second sidelink control message based on the first reserved resource overlapping with the second reserved resource in time and frequency, a signal strength for a signal received from the second UE, the third UE, or both, and at least one channel access parameter for communications with the second UE, the third UE, or both. The operations of 1315 may be performed in accordance with examples as disclosed herein. In some examples, aspects of the operations of 1315 may be performed by a conflict indication transmitting manager 1130 as described with reference to FIG. 11.

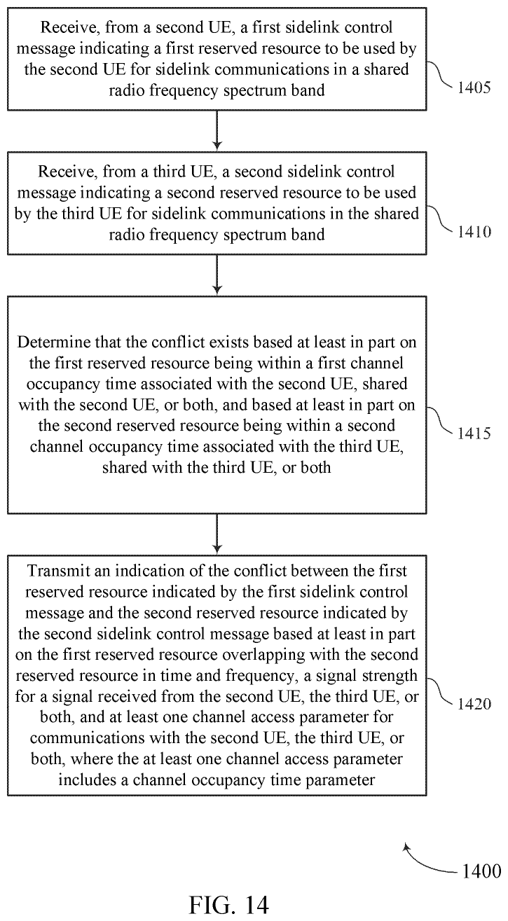

FIG. 14 shows a flowchart illustrating a method 1400 that supports techniques for channel access-aware conflict determination for unlicensed sidelink bands in accordance with one or more aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1405, the method may include receiving, from a second UE, a first sidelink control message indicating a first reserved resource to be used by the second UE for sidelink communications in a shared radio frequency spectrum band. The operations of 1405 may be performed in accordance with examples as disclosed herein. In some examples, aspects of the operations of 1405 may be performed by a sidelink message receiving manager 1125 as described with reference to FIG. 11.

At 1410, the method may include receiving, from a third UE, a second sidelink control message indicating a second reserved resource to be used by the third UE for sidelink communications in the shared radio frequency spectrum band. The operations of 1410 may be performed in accordance with examples as disclosed herein. In some examples, aspects of the operations of 1410 may be performed by a sidelink message receiving manager 1125 as described with reference to FIG. 11.

At 1415, the method may include determining that the conflict exists based on the first reserved resource being within a first COT associated with the second UE, shared with the second UE, or both, and based on the second reserved resource being within a second COT associated with the third UE, shared with the third UE, or both. The operations of 1415 may be performed in accordance with examples as disclosed herein. In some examples, aspects of the operations of 1415 may be performed by a COT manager 1135 as described with reference to FIG. 11.

At 1420, the method may include transmitting an indication of the conflict between the first reserved resource indicated by the first sidelink control message and the second reserved resource indicated by the second sidelink control message based on the first reserved resource overlapping with the second reserved resource in time and frequency, a signal strength for a signal received from the second UE, the third UE, or both, and at least one channel access parameter for communications with the second UE, the third UE, or both, where the at least one channel access parameter includes a COT parameter. The operations of 1420 may be performed in accordance with examples as disclosed herein. In some examples, aspects of the operations of 1420 may be performed by a conflict indication transmitting manager 1130 as described with reference to FIG. 11.

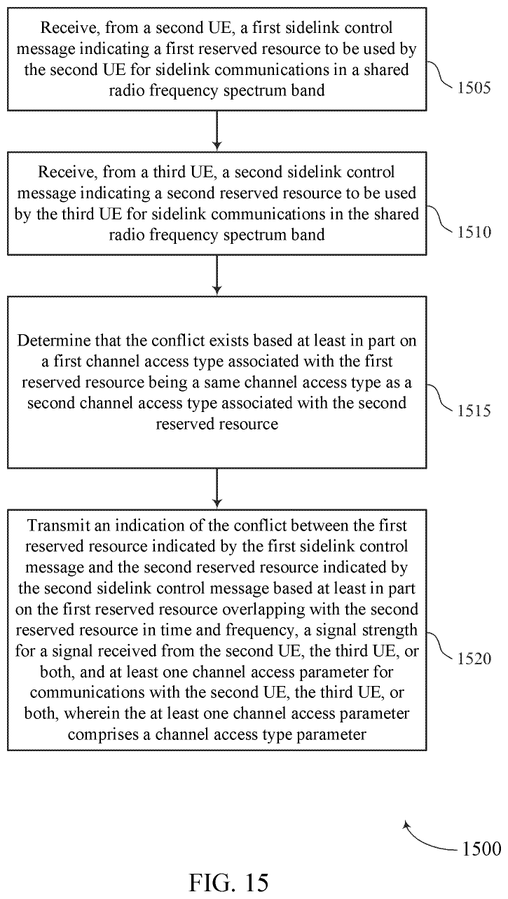

FIG. 15 shows a flowchart illustrating a method 1500 that supports techniques for channel access-aware conflict determination for unlicensed sidelink bands in accordance with one or more aspects of the present disclosure. The operations of the method 1500 may be implemented by a UE or its components as described herein. For example, the operations of the method 1500 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1505, the method may include receiving, from a second UE, a first sidelink control message indicating a first reserved resource to be used by the second UE for sidelink communications in a shared radio frequency spectrum band. The operations of 1505 may be performed in accordance with examples as disclosed herein. In some examples, aspects of the operations of 1505 may be performed by a sidelink message receiving manager 1125 as described with reference to FIG. 11.

At 1510, the method may include receiving, from a third UE, a second sidelink control message indicating a second reserved resource to be used by the third UE for sidelink communications in the shared radio frequency spectrum band. The operations of 1510 may be performed in accordance with examples as disclosed herein. In some examples, aspects of the operations of 1510 may be performed by a sidelink message receiving manager 1125 as described with reference to FIG. 11.

At 1515, the method may include determining that the conflict exists based on a first channel access type associated with the first reserved resource being a same channel access type as a second channel access type associated with the second reserved resource. The operations of 1515 may be performed in accordance with examples as disclosed herein. In some examples, aspects of the operations of 1515 may be performed by a channel access type manager 1140 as described with reference to FIG. 11.

At 1520, the method may include transmitting an indication of the conflict between the first reserved resource indicated by the first sidelink control message and the second reserved resource indicated by the second sidelink control message based on the first reserved resource overlapping with the second reserved resource in time and frequency, a signal strength for a signal received from the second UE, the third UE, or both, and at least one channel access parameter for communications with the second UE, the third UE, or both, where the at least one channel access parameter includes a channel access type parameter. The operations of 1520 may be performed in accordance with examples as disclosed herein. In some examples, aspects of the operations of 1520 may be performed by a conflict indication transmitting manager 1130 as described with reference to FIG. 11.

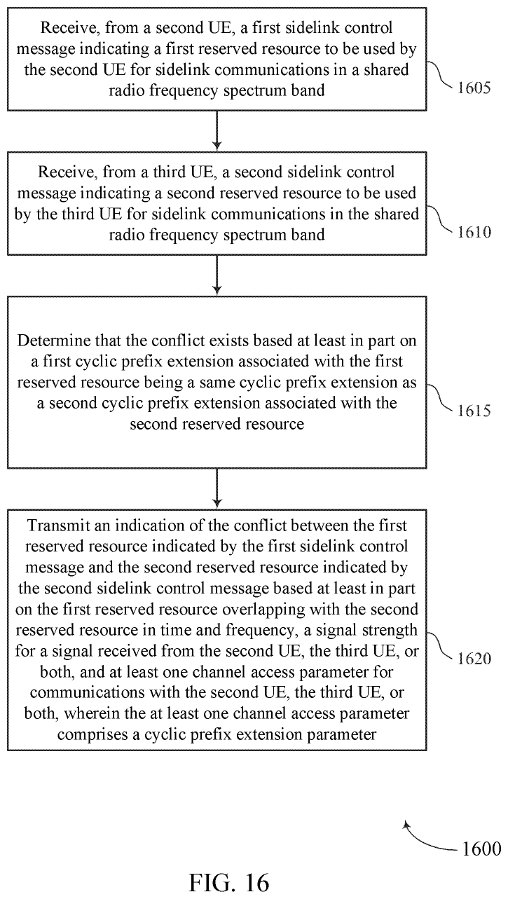

FIG. 16 shows a flowchart illustrating a method 1600 that supports techniques for channel access-aware conflict determination for unlicensed sidelink bands in accordance with one or more aspects of the present disclosure. The operations of the method 1600 may be implemented by a UE or its components as described herein. For example, the operations of the method 1600 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1605, the method may include receiving, from a second UE, a first sidelink control message indicating a first reserved resource to be used by the second UE for sidelink communications in a shared radio frequency spectrum band. The operations of 1605 may be performed in accordance with examples as disclosed herein. In some examples, aspects of the operations of 1605 may be performed by a sidelink message receiving manager 1125 as described with reference to FIG. 11.

At 1610, the method may include receiving, from a third UE, a second sidelink control message indicating a second reserved resource to be used by the third UE for sidelink communications in the shared radio frequency spectrum band. The operations of 1610 may be performed in accordance with examples as disclosed herein. In some examples, aspects of the operations of 1610 may be performed by a sidelink message receiving manager 1125 as described with reference to FIG. 11.

At 1615, the method may include determining that the conflict exists based on a first CPE associated with the first reserved resource being a same CPE as a second CPE associated with the second reserved resource. The operations of 1615 may be performed in accordance with examples as disclosed herein. In some examples, aspects of the operations of 1615 may be performed by a CPE manager 1145 as described with reference to FIG. 11.

At 1620, the method may include transmitting an indication of the conflict between the first reserved resource indicated by the first sidelink control message and the second reserved resource indicated by the second sidelink control message based on the first reserved resource overlapping with the second reserved resource in time and frequency, a signal strength for a signal received from the second UE, the third UE, or both, and at least one channel access parameter for communications with the second UE, the third UE, or both, where the at least one channel access parameter includes a CPE parameter. The operations of 1620 may be performed in accordance with examples as disclosed herein. In some examples, aspects of the operations of 1620 may be performed by a conflict indication transmitting manager 1130 as described with reference to FIG. 11.

The following provides an overview of aspects of the present disclosure:

### Aspect 1

A method for wireless communication at a first UE, comprising: receiving, from a second UE, a first sidelink control message indicating a first reserved resource to be used by the second UE for sidelink communications in a shared radio frequency spectrum band; receiving, from a third UE, a second sidelink control message indicating a second reserved resource to be used by the third UE for sidelink communications in the shared radio frequency spectrum band; and transmitting an indication of a conflict between the first reserved resource indicated by the first sidelink control message and the second reserved resource indicated by the second sidelink control message based at least in part on the first reserved resource overlapping with the second reserved resource in time and frequency, a signal strength for a signal received from the second UE, the third UE or both, and at least one channel access parameter for communications with the second UE, the third UE or both.

### Aspect 2

The method of aspect 1, further comprising: determining that the conflict exists based at least in part on the first reserved resource being within a first COT associated with the second UE, shared with the second UE, or both, and based at least in part on the second reserved resource being within a second COT associated with the third UE, shared with the third UE, or both, wherein the at least one channel access parameter comprises a COT parameter.

### Aspect 3

The method of any of aspects 1 through 2, further comprising: determining that the conflict exists based at least in part on a first channel access type associated with the first reserved resource being a same channel access type as a second channel access type associated with the second reserved resource, wherein the at least one channel access parameter comprises a channel access type parameter.

### Aspect 4

The method of any of aspects 1 through 3, further comprising: determining that the conflict exists based at least in part on a first CPE associated with the first reserved resource being a same CPE as a second CPE associated with the second reserved resource, wherein the at least one channel access parameter comprises a CPE parameter.

### Aspect 5

The method of any of aspects 1 through 4, further comprising: determining that the conflict exists based at least in part on the first reserved resource being within a first COT associated with the second UE, shared with the second UE, or both, and based at least in part on the second reserved resource being within a second COT associated with the third UE, shared with the third UE, or both, and based at least in part on a first CPE associated with the first reserved resource being a same CPE as a second CPE associated with the second reserved resource, wherein the at least one channel access parameter comprises a COT parameter and a CPE parameter.

### Aspect 6

The method of any of aspects 1 through 5, further comprising: determining that the conflict exists based at least in part on a first channel access type associated with the first reserved resource being a same channel access type as a second channel access type associated with the second reserved resource, and based at least in part on a first CPE associated with the first reserved resource being a same CPE as a second CPE associated with the second reserved resource, wherein the at least one channel access parameter comprises a channel access type parameter and a CPE parameter.

### Aspect 7

The method of any of aspects 1 through 6, further comprising: determining that the conflict exists based at least in part on a quantity of conflicting resources satisfying a quantity threshold, wherein the quantity of conflicting resources is identified based at least in part on, for each respective resource of a plurality of resources for a plurality of UEs coordinated by the first UE, whether a signal strength for a signal received on the respective resource satisfies a signal strength threshold.

### Aspect 8

The method of any of aspects 1 through 7, further comprising: determining that the conflict between the first reserved resource and the second reserved resource exists based at least in part on a first signal strength associated with a first signal received from the second UE satisfying a signal strength threshold.

### Aspect 9

The method of aspect 8, further comprising: determining that the conflict between the first reserved resource and the second reserved resource exists based at least in part on a difference between the first signal strength associated with the first signal received from the second UE and a second signal strength associated with a second signal received from the third UE satisfying a signal strength difference threshold.

### Aspect 10

The method of any of aspects 1 through 9, further comprising: transmitting the indication of the conflict to the second UE based at least in part on a first transmission of the second UE indicated by the first sidelink control message having a lower priority than a second transmission of the third UE indicated by the second sidelink control message.

### Aspect 11

The method of aspect 10, further comprising: receiving, from the second UE responsive to the indication of the conflict, a third sidelink control message identifying a third reserved resource different from the first reserved resource to be used by the second UE for sidelink communications.

### Aspect 12

The method of any of aspects 1 through 11, further comprising: receiving, from the second UE, capability signaling via an SCI message indicating that the second UE is capable of receiving the indication of the conflict; and transmitting the indication of the conflict to the second UE via a physical sidelink feedback channel based at least in part on receiving the capability signaling.

### Aspect 13

An apparatus for wireless communication at a first UE, comprising a processor; memory coupled with the processor; and instructions stored in the memory and executable by the processor to cause the apparatus to perform a method of any of aspects 1 through 12.

### Aspect 14

An apparatus for wireless communication at a first UE, comprising at least one means for performing a method of any of aspects 1 through 12.

### Aspect 15

A non-transitory computer-readable medium storing code for wireless communication at a first UE, the code comprising instructions executable by a processor to perform a method of any of aspects 1 through 12.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a first user equipment (UE), comprising:
a processor;
memory coupled with the processor; and
instructions stored in the memory and executable by the processor to cause the apparatus to:
receive, from a second UE, a first sidelink control message indicating a first reserved resource to be used by the second UE for sidelink communications in a shared radio frequency spectrum band;
receive, from a third UE, a second sidelink control message indicating a second reserved resource to be used by the third UE for sidelink communications in the shared radio frequency spectrum band; and
transmit an indication of a conflict between the first reserved resource indicated by the first sidelink control message and the second reserved resource indicated by the second sidelink control message based at least in part on the first reserved resource overlapping with the second reserved resource in time and frequency, a signal strength for a signal received from the second UE, the third UE, or both, and at least one channel access parameter for communications with the second UE, the third UE, or both.

2. The apparatus of claim 1, wherein the instructions are further executable by the processor to cause the apparatus to:
determine that the conflict exists based at least in part on the first reserved resource being within a first channel occupancy time associated with the second UE, shared with the second UE, or both, and based at least in part on the second reserved resource being within a second channel occupancy time associated with the third UE, shared with the third UE, or both, wherein the at least one channel access parameter comprises a channel occupancy time parameter.

3. The apparatus of claim 1, wherein the instructions are further executable by the processor to cause the apparatus to:
determine that the conflict exists based at least in part on a first channel access type associated with the first reserved resource being a same channel access type as a second channel access type associated with the second reserved resource, wherein the at least one channel access parameter comprises a channel access type parameter.

4. The apparatus of claim 1, wherein the instructions are further executable by the processor to cause the apparatus to:
determine that the conflict exists based at least in part on a first cyclic prefix extension associated with the first reserved resource being a same cyclic prefix extension as a second cyclic prefix extension associated with the second reserved resource, wherein the at least one channel access parameter comprises a cyclic prefix extension parameter.

5. The apparatus of claim 1, wherein the instructions are further executable by the processor to cause the apparatus to:
determine that the conflict exists based at least in part on the first reserved resource being within a first channel occupancy time associated with the second UE, shared with the second UE, or both, and based at least in part on the second reserved resource being within a second channel occupancy time associated with the third UE, shared with the third UE, or both, and based at least in part on a first cyclic prefix extension associated with the first reserved resource being a same cyclic prefix extension as a second cyclic prefix extension associated with the second reserved resource, wherein the at least one channel access parameter comprises a channel occupancy time parameter and a cyclic prefix extension parameter.

6. The apparatus of claim 1, wherein the instructions are further executable by the processor to cause the apparatus to:
determine that the conflict exists based at least in part on a first channel access type associated with the first reserved resource being a same channel access type as a second channel access type associated with the second reserved resource, and based at least in part on a first cyclic prefix extension associated with the first reserved resource being a same cyclic prefix extension as a second cyclic prefix extension associated with the second reserved resource, wherein the at least one channel access parameter comprises a channel access type parameter and a cyclic prefix extension parameter.

7. The apparatus of claim 1, wherein the instructions are further executable by the processor to cause the apparatus to:
determine that the conflict exists based at least in part on a quantity of conflicting resources satisfying a quantity threshold, wherein the quantity of conflicting resources is identified based at least in part on, for each respective resource of a plurality of resources for a plurality of UEs coordinated by the first UE, whether a signal strength for a signal received on the respective resource satisfies a signal strength threshold.

8. The apparatus of claim 1, wherein the instructions are further executable by the processor to cause the apparatus to:
determine that the conflict between the first reserved resource and the second reserved resource exists based at least in part on a first signal strength associated with a first signal received from the second UE satisfying a signal strength threshold.

9-11. (canceled)

12. The apparatus of claim 1, wherein the instructions are further executable by the processor to cause the apparatus to:
receive, from the second UE, capability signaling via a sidelink control information message indicating that the second UE is capable of receiving the indication of the conflict; and
transmit the indication of the conflict to the second UE via a physical sidelink feedback channel based at least in part on receiving the capability signaling.

13. A method for wireless communication at a first user equipment (UE), comprising:
receiving, from a second UE, a first sidelink control message indicating a first reserved resource to be used by the second UE for sidelink communications in a shared radio frequency spectrum band;
receiving, from a third UE, a second sidelink control message indicating a second reserved resource to be used by the third UE for sidelink communications in the shared radio frequency spectrum band; and
transmitting an indication of a conflict between the first reserved resource indicated by the first sidelink control message and the second reserved resource indicated by the second sidelink control message based at least in part on the first reserved resource overlapping with the second reserved resource in time and frequency, a signal strength for a signal received from the second UE, the third UE, or both, and at least one channel access parameter for communications with the second UE, the third UE, or both.

14. The method of claim 13, further comprising:
determining that the conflict exists based at least in part on the first reserved resource being within a first channel occupancy time associated with the second UE, shared with the second UE, or both, and based at least in part on the second reserved resource being within a second channel occupancy time associated with the third UE, shared with the third UE, or both, wherein the at least one channel access parameter comprises a channel occupancy time parameter.

15. The method of claim 13, further comprising:
determining that the conflict exists based at least in part on a first channel access type associated with the first reserved resource being a same channel access type as a second channel access type associated with the second reserved resource, wherein the at least one channel access parameter comprises a channel access type parameter.

16. The method of claim 13, further comprising:
determining that the conflict exists based at least in part on a first cyclic prefix extension associated with the first reserved resource being a same cyclic prefix extension as a second cyclic prefix extension associated with the second reserved resource, wherein the at least one channel access parameter comprises a cyclic prefix extension parameter.

17. The method of claim 13, further comprising:
determining that the conflict exists based at least in part on the first reserved resource being within a first channel occupancy time associated with the second UE, shared with the second UE, or both, and based at least in part on the second reserved resource being within a second channel occupancy time associated with the third UE, shared with the third UE, or both, and based at least in part on a first cyclic prefix extension associated with the first reserved resource being a same cyclic prefix extension as a second cyclic prefix extension associated with the second reserved resource, wherein the at least one channel access parameter comprises a channel occupancy time parameter and a cyclic prefix extension parameter.

18. The method of claim 13, further comprising:
determining that the conflict exists based at least in part on a first channel access type associated with the first reserved resource being a same channel access type as a second channel access type associated with the second reserved resource, and based at least in part on a first cyclic prefix extension associated with the first reserved resource being a same cyclic prefix extension as a second cyclic prefix extension associated with the second reserved resource, wherein the at least one channel access parameter comprises a channel access type parameter and a cyclic prefix extension parameter.

19. The method of claim 13, further comprising:
determining that the conflict exists based at least in part on a quantity of conflicting resources satisfying a quantity threshold, wherein the quantity of conflicting resources is identified based at least in part on, for each respective resource of a plurality of resources for a plurality of UEs coordinated by the first UE, whether a signal strength for a signal received on the respective resource satisfies a signal strength threshold.

20. (canceled)

21. The method of claim 20, further comprising:
determining that the conflict between the first reserved resource and the second reserved resource exists based at least in part on a difference between the first signal strength associated with the first signal received from the second UE and a second signal strength associated with a second signal received from the third UE satisfying a signal strength difference threshold.

22. The method of claim 13, further comprising:
transmitting the indication of the conflict to the second UE based at least in part on a first transmission of the second UE indicated by the first sidelink control message having a lower priority than a second transmission of the third UE indicated by the second sidelink control message.

23. (canceled)

24. The method of claim 13, further comprising:
receiving, from the second UE, capability signaling via a sidelink control information message indicating that the second UE is capable of receiving the indication of the conflict; and
transmitting the indication of the conflict to the second UE via a physical sidelink feedback channel based at least in part on receiving the capability signaling.

25-28. (canceled)

29. An apparatus for wireless communication at a first user equipment (UE), comprising:
means for receiving, from a second UE, a first sidelink control message indicating a first reserved resource to be used by the second UE for sidelink communications in a shared radio frequency spectrum band;
means for receiving, from a third UE, a second sidelink control message indicating a second reserved resource to be used by the third UE for sidelink communications in the shared radio frequency spectrum band; and
means for transmitting an indication of a conflict between the first reserved resource indicated by the first sidelink control message and the second reserved resource indicated by the second sidelink control message based at least in part on the first reserved resource overlapping with the second reserved resource in time and frequency, a signal strength for a signal received from the second UE, the third UE, or both, and at least one channel access parameter for communications with the second UE, the third UE, or both.

30. (canceled)
